(19) United States
(12) Patent Application Publication
(10) Pub. No.: US 2026/0204026 A1
(43) Pub. Date: Jul. 16, 2026

(54) SYSTEM AND METHOD FOR REAL-TIME HARMONIZATION OF DIGITAL OBJECTS WITH PHYSICAL ENVIRONMENT

(71) Applicant: Flying Flamingos India Private Limited, Bangalore (IN)

(72) Inventors: Amit Gaiki, Bangalore (IN); Shourya Agarwal, Ajmer (IN); Avijit Kundal, SAS Nagar (IN); Yaswanth NSN, Andhra Pradesh (IN)

(73) Assignee: Flying Flamingos India Private Limited, Bangalore (IN)

(21) Appl. No.: 19/435,936

(22) Filed: Dec. 30, 2025

(30) Foreign Application Priority Data
Dec. 30, 2024 (IN) 202441104503

(51) Int. Cl. G06T 19/00; G06T 5/92; G06T 7/11; G06T 7/194; G06T 7/90; G06T 15/04; G06T 15/50; G06T 19/20

(52) U.S. Cl. CPC G06T 19/006; G06T 5/92; G06T 7/11; G06T 7/194; G06T 7/90; G06T 15/04; G06T 15/506; G06T 19/20; G06T 2207/10024; G06T 2207/20208; G06T 2215/12; G06T 2219/2004; G06T 2219/2012

(57) ABSTRACT

The present disclosure provides a system and method for harmonizing digital objects with lighting conditions of a physical environment. The system includes one or more processors and a non-transitory memory storing instructions. The instructions, when executed by the one or more processors, cause the system to receive an image of the physical environment captured by one or more sensors of a user device, analyze the image to determine environmental parameters, and generate harmonization data. The harmonization data is applied to the digital object using an artificial intelligence model and/or a non-artificial intelligence algorithm to achieve visual coherence with the physical environment. The system implements a modular mixed reality engine for rendering the harmonized digital object and dynamically optimizing the rendered digital object in real time.

### TECHNICAL FIELD

The present invention relates to the field of mixed reality systems, and more particularly to a system and a method for harmonizing digital objects with physical environments in real time using modular mixed reality engines.

### BACKGROUND

Rapid development of mixed Reality (MR) technologies has significantly enhanced the potential for blending digital and physical environments. mixed Reality enables users to interact with virtual objects in real time within their physical space. In addition, mixed reality offers highly immersive and interactive experiences. However, a persistent challenge remains in delivering seamless integration of digital objects within mixed reality environments. The seamless integration challenge becomes even more pronounced when the digital objects are placed in lightweight, instant application experiences.

Current solutions often struggle to maintain realism during the placement and interaction of objects within mixed reality spaces. The inability to accurately adapt digital objects in real time to the changing lighting, and spatial geometry of the physical environment limits the immersive quality of the experience. Also, the instant application experiences must provide users with immediate and responsive interaction without the need for complex setups or extended processing times. However, the persistent harmonization issue acts as a major deterrent for users expecting immediate and responsive interactions. The existing mixed reality technologies often fail to deliver a level of flexibility and responsiveness without complex calibration processes.

Furthermore, many mixed reality systems do not fully leverage the capabilities of device sensors such as cameras, accelerometers, and gyroscopes. These sensors are often underutilized in traditional mixed reality applications, resulting in a lack of real-time, adaptive responses to changes in the physical environment. For instance, camera-based spatial mapping and real-time tracking of the user’s movements are frequently not fully integrated into the mixed reality experience, leading to poor responsiveness when interacting with digital objects. This inability to dynamically harmonize digital content with real-world elements in relation to real-time user movements, detracts from the realism and engagement of mixed reality experiences.

Based on the above stated drawbacks in the existing mixed reality systems, there is a significant need for a solution for executing real time, dynamic harmonization of digital objects within mixed reality environments, particularly in instant apps.

### SUMMARY

In an aspect, a system is disclosed. The system is configured to enable harmonization of digital objects with lighting conditions of a physical environment in real time. The system includes one or more processors and a non-transitory memory storing instructions. The instructions, when executed by the one or more processors, cause the system to receive, from a user device, an image of a physical environment captured by one or more sensors embedded in the user device. The system analyzes the received image to generate one or more environmental parameters representative of lighting and color characteristics of the physical environment. The system generates harmonization data based on the one or more environmental parameters. The harmonization data includes one or more adjustments for at least one of lighting alignment, color consistency, saturation, or perspective scaling of at least one digital object. The system applies the harmonization data to the at least one digital object to adjust the at least one digital object for visual coherence with the physical environment. The harmonization data is generated using at least one of an artificial intelligence model or a non-artificial intelligence algorithm. The system renders the harmonized at least one digital object using a modular mixed reality engine. The system dynamically optimizes the rendered at least one digital object based on characteristics extracted from the received image to maintain the visual coherence of the harmonized at least one digital object with the physical environment.

In an embodiment, the one or more environmental parameters include at least one of a high dynamic range image (HDRi) environment map, a CubeMap, color distribution, a brightness value, or a color temperature.

In an embodiment, the applying of the harmonization data includes at least one of adjusting pixel-level saturation values of the at least one digital object, aligning the at least one digital object with background-to-foreground color transitions of the received image, and correcting scale or perspective of the at least one digital object relative to the physical environment.

In an embodiment, the scale correction of the at least one digital object is performed based on depth information derived from a high dynamic range image (HDRi) environment map.

In an embodiment, the artificial intelligence model includes at least one of a pixel-consistency transformation network (PCTNet), a dual-color harmonization network (DucoNet), a saturation estimation model, or a diffusion-based relighting model.

In an embodiment, the applying of the harmonization data includes performing pixel-level color temperature correction of the at least one digital object to align with the lighting conditions of the physical environment.

In an embodiment, the artificial intelligence model is configured to correct residual differences between the rendered at least one digital object and the captured image of the physical environment. The correction of the residual differences by the artificial intelligence model includes receiving the captured image of the physical environment and the rendered at least one digital object, extracting pixel-level features from the captured image, generating feature representations of the rendered at least one digital object, comparing the extracted pixel-level features of the captured image with the feature representations of the rendered at least one digital object, and adjusting visual parameters of the rendered at least one digital object based on the comparison to achieve alignment with the captured image. The feature representations may include at least luminance, chrominance, and saturation characteristics.

In another embodiment, the non-artificial intelligence algorithm is configured to correct residual differences between the rendered at least one digital object and the captured image of the physical environment. The non-artificial intelligence algorithm includes a background MixNMatch algorithm. The algorithm includes a first step of receiving a rendered output of the at least one digital object and the captured image of the physical environment. The algorithm includes a second step of segmenting background regions of the captured image. The algorithm includes a third step of extracting color and luminance features from the segmented background regions. The algorithm includes a fourth step of comparing the extracted color and luminance features with corresponding features of the rendered output. The algorithm includes a final step of adjusting, in real time, pixel values of the rendered output based on the comparison to reduce discrepancies or the residual differences between the background regions and the rendered output.

In an embodiment, the dynamic optimization of the rendered at least one digital object is performed using at least one of the artificial intelligence model and the non-artificial intelligence algorithm. The dynamic optimization includes a color correction operation. The color correction operation includes mapping pixel intensity values of the rendered at least one digital object to pixel intensity distributions of the captured image of the physical environment. Additionally, the color correction operation includes adjusting the pixel intensity values of the rendered at least one digital object based on the mapping.

In another aspect, a method is disclosed. The method performs harmonization of digital objects with lighting conditions of a physical environment in real time. The method includes receiving, from a user device, an image of the physical environment captured by one or more sensors embedded in the user device. The method includes analyzing the received image to generate one or more environmental parameters representative of lighting and color characteristics of the physical environment. The method includes generating, using at least one of an artificial intelligence model or a non-artificial intelligence algorithm, harmonization data based on the one or more environmental parameters. The harmonization data includes one or more adjustments for at least one of lighting alignment, color consistency, saturation, or perspective scaling of at least one digital object. Further, the method includes applying the harmonization data to the at least one digital object to adjust the at least one digital object for enabling visual coherence with the physical environment. In addition, the method includes rendering the harmonized at least one digital object. Also, the method includes dynamically optimizing the rendered at least one digital object based on characteristics extracted from the received image to maintain the visual coherence of the harmonized at least one digital object with the physical environment.

In yet another aspect of the present invention, a non-transitory computer-readable medium is disclosed. The non-transitory computer-readable medium stores instructions that when executed by one or more processors, cause a system to perform a method for harmonizing digital objects with lighting conditions of a physical environment in real time. The method includes receiving an image of the physical environment captured by one or more sensors embedded in the user device. The method includes analyzing the received image to generate one or more environmental parameters representative of lighting and color characteristics of the physical environment. The method includes generating harmonization data based on the one or more environmental parameters. The harmonization data includes one or more adjustments for at least one of lighting alignment, color consistency, saturation, or perspective scaling of at least one digital object. Further, the method includes applying the harmonization data to the at least one digital object to adjust the at least one digital object for visual coherence with the physical environment. The harmonization data is generated using at least one of an artificial intelligence model or a non-artificial-intelligence algorithm. The method includes rendering the harmonized at least one digital object using a modular mixed-reality engine. Also, the method includes dynamically optimizing the rendered at least one digital object based on characteristics extracted from the received image to maintain visual coherence of the harmonized at least one digital object with the physical environment.

### BRIEF DESCRIPTION OF DRAWINGS

Having thus described the disclosure in general terms, references will now be made to the accompanying figures, wherein:

FIG. 1 illustrates an interactive system environment depicting components for real-time harmonization of digital objects within a mixed reality (MR) environment, in accordance with various embodiments of the present disclosure;

FIG. 2 illustrates a block diagram of a system for enabling the real-time harmonization of the digital objects within the mixed reality (MR) environment, in accordance with various embodiments of the present disclosure;

FIG. 3 illustrates a flowchart of a method for the real-time harmonization of the digital objects within the mixed reality (MR) environment, in accordance with various embodiments of the present disclosure; and

FIG. 4 illustrates a block diagram of an exemplary computing device configured, in accordance with various embodiments of the present disclosure.

It should be noted that the accompanying figures are intended to present illustrations of exemplary embodiments of the present disclosure. The figures are not intended to limit the scope of the present disclosure. It should also be noted that accompanying figures are not necessarily drawn to scale.

### DETAILED DESCRIPTION OF INVENTION

Some embodiments of the disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described. Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

While the present invention is described herein by way of example using embodiments, those skilled in the art will recognize that the invention is not limited to the embodiments described and are not intended to represent the scale of the various components. It should be understood that the detailed description thereto is not intended to limit the invention to the particular form disclosed, but on the contrary, the invention is to cover all modifications, equivalents, and alternatives falling within the scope of the present invention as defined by the appended claim. As used throughout this description, the word "may" is used in a permissive sense (i.e. meaning having the potential to), rather than the mandatory sense, (i.e. meaning must). Further, the words "a" or "an" mean "at least one” and the word “plurality” means “one or more” unless otherwise mentioned. Furthermore, the terminology and phraseology used herein is solely used for descriptive purposes and should not be construed as limiting in scope. Language such as "including," "comprising," "having," "containing," or "involving," and variations thereof, is intended to be broad and encompass the subject matter listed thereafter, equivalents, and additional subject matter not recited, and is not intended to exclude other additives, components, integers, or steps. Likewise, the term "comprising" is considered synonymous with the terms "including" or "containing" for applicable legal purposes. Any discussion of documents, acts, materials, devices, articles, and the like is included in the specification solely for the purpose of providing a context for the present invention. It is not suggested or represented that any or all of these matters form part of the prior art base or were common general knowledge in the field relevant to the present invention.

The present invention is described hereinafter by various embodiments. The invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. The values and ranges are to be treated as examples only, and are not intended to limit the scope of the claims. In addition, a number of system architectures are identified as suitable for various facets of the implementations. The system architectures are to be treated as exemplary and are not intended to limit the scope of the invention.

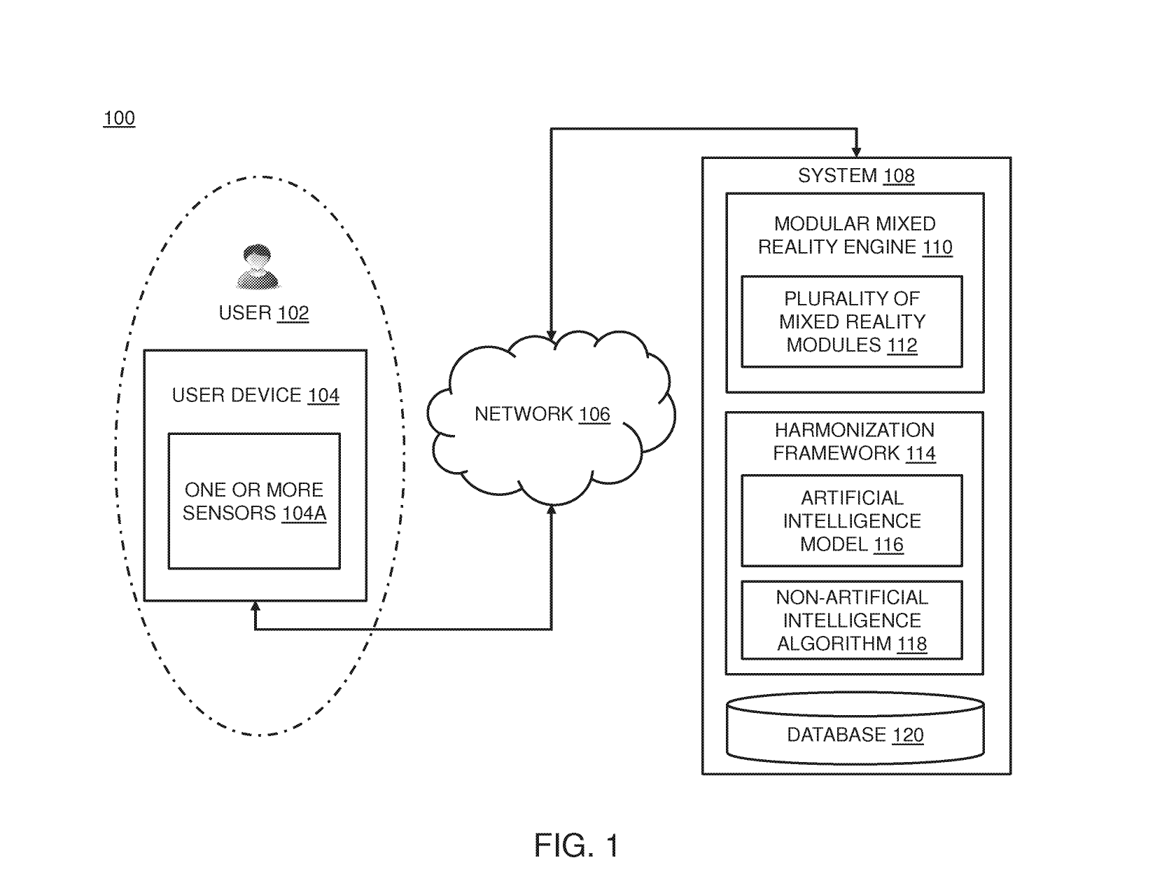

FIG. 1 illustrates an exemplary interactive computing environment 100 for harmonizing digital objects with a surrounding physical environment in real time, in accordance with various embodiments of the present disclosure. The interactive computing environment 100 facilitates the harmonization of the digital objects with lighting conditions associated with the surrounding physical environment. The harmonization broadly refers to a perceptual alignment and visual blending of virtual or digital objects with real-world surroundings to achieve a coherent mixed reality experience. In addition, the harmonization process ensures that the digital objects appear contextually consistent with ambient characteristics of a physical space. The characteristics may include illumination, tone, and spatial perspective of the physical space or environment. Also, the harmonization process establishes a sense of realism and continuity between virtual and physical elements. Moreover, the harmonization process ensures that a rendered digital content or object does not appear visually detached or artificially imposed on the physical environment. The rendered digital objects exhibit a balanced integration within a user’s field of view. The harmonization process aids in maintaining perceptual depth, visual plausibility, and environmental coherence across varying lighting and contextual conditions.

The interactive computing environment 100 is configured to capture image data from the physical environment, analyze lighting and color parameters, and render harmonized mixed reality (MR) content on a user device 104 associated with a user 102. The interactive computing environment 100 includes the user device 104, a network 106, a system 108, and a database 120. The user device 104 is equipped with one or more sensors 104a. The one or more sensors 104a capture information related to the physical environment and communicate with the system 108 via the network 106. The components of the interactive computing environment 100 are operatively coupled and cooperatively function to enable the harmonization, adaptive rendering, and dynamic optimization of mixed reality content based on the lighting conditions of the physical environment.

The mixed reality experience refers to a digitally enhanced immersive environment that blends virtual objects or augmentations with the physical environment in real time. The mixed reality experience allows the user 102 to perceive and interact with digital and physical components in a visually coherent manner. The mixed reality content includes digital assets, holograms, and interactive objects that are adjusted for lighting alignment, color consistency, and saturation balance with the surrounding environment. The rendering of mixed reality content is dynamically optimized based on captured image data, extracted environmental parameters, and device capabilities. In addition, the mixed reality content may include color-corrected overlays, light-adaptive elements, or real-world object harmonizations synchronized with contextual inputs from the one or more sensors 104a of the user device 104.

The user 102 may represent an individual interacting with the harmonized mixed reality content through the user device 104. The user 102 may initiate a mixed reality experience by scanning a QR code, selecting an application link, or activating mixed reality interaction through one or more scannable or link-based mechanisms. In an embodiment of the present disclosure, the user device 104 refers to any suitable user equipment configured to capture images of the physical environment, receive contextual information, and render harmonized mixed reality content. Examples of the user device 104 include a smartphone, tablet, smart glasses, wearable computing device, augmented reality (AR) headsets, and the like. The user device 104 may host a runtime environment capable of executing the real-time harmonization of the digital objects with the lighting conditions, without requiring full application installation. Accordingly, the user device 104 functions as an interactive display interface for rendering the harmonized mixed reality content.

In certain scenarios, the initiation may occur automatically in response to contextual triggers such as geolocation detection, object recognition, or ambient light changes captured by the one or more sensors 104a. For example, when the user 102 points the user device 104 toward a predefined marker, a digital object may appear aligned with the real-world surface, reflecting lighting and shadows consistent with the physical scene. Similarly, in an indoor environment, the mixed reality experience may activate upon detecting a spatial layout or surface geometry corresponding to a known template. The interaction between the user 102 and the harmonized digital content creates an immersive and context-aware environment in which virtual and physical elements coexist seamlessly.

In various embodiments, the user 102 may interact with the harmonized mixed reality content through multiple input modalities supported by the user device 104. The input modalities may include gesture-based controls detected by integrated cameras, touch-based interaction via the display surface, or voice commands processed through embedded microphones. For instance, the user 102 may resize, reposition, or rotate a digital object using simple hand movements recognized by vision-based sensors, or verbally instruct the system to alter the illumination or material appearance of a rendered element. In some scenarios, the system 108 may adapt the virtual content in response to user gaze direction or device orientation, thereby maintaining natural alignment between the digital and physical spaces. Such multimodal interaction mechanisms enhance intuitiveness and immersion, allowing the user 102 to engage dynamically with harmonized digital objects in real-world contexts.

The user device 104 includes one or more sensors 104a. In an embodiment, the one or more sensors 104a may include a camera sensor, a depth sensor, an inertial measurement unit (IMU), a proximity sensor, or any combination thereof. The one or more sensors 104a are configured to capture at least lighting, color, and spatial data of the physical environment for analysis and optimization of the rendered mixed reality content.

The network 106 may include wired or wireless channels such as 5G, Wi-Fi, or satellite connections, enabling low-latency synchronization of content and lighting harmonization updates. The network 106 facilitates real-time exchange of sensor data, harmonization parameters, and rendering instructions between the user device 104, the system 108, and external cloud infrastructure. In some embodiments, the network 106 supports adaptive bandwidth allocation and edge-computing integration to ensure continuous operation even under fluctuating network conditions. The network 106 layer may employ encryption, packet prioritization, and compression protocols to maintain data integrity and responsiveness during transmission of high-volume mixed reality assets. Examples of communication frameworks supported by the network 106 include Internet Protocol-based communication, local peer-to-peer connectivity, or hybrid architectures combining local caching with remote server synchronization.

The network 106 serves as the backbone of the interactive computing environment 100. The network 106 enables seamless communication between the user device 104, the system 108, and the database 120. Various entities in the environment 100 may connect to the network 106 using wired and wireless protocols, such as Transmission Control Protocol and Internet Protocol (TCP/IP), User Datagram Protocol (UDP), 2nd Generation (2G), 3rd Generation (3G), 4th Generation (4G), 5th Generation (5G), 6th Generation (6G) communication protocols, Long Term Evolution (LTE), future-generation protocols, or combinations thereof. The robust connectivity ensures timely transmission of image data, harmonization parameters, and rendering instructions required for maintaining real-time lighting and color coherence in mixed reality experiences.

The network 106 provides a scalable infrastructure that supports synchronization between the user device 104, the system 108, and the database 120. In some implementations, the network 106 includes internet, intranet, Wi-Fi, or other wired and wireless technologies. The connectivity allows captured images, environmental parameters, and harmonization data to be exchanged efficiently. The efficient exchange ensures that the rendered digital objects remain visually aligned with the lighting conditions and the color characteristics of the physical environment.

The system 108 communicates with the user device 104 through the network 106. The user device 104, the network 106, and the system 108 operate cooperatively to establish a continuous bidirectional data flow that supports real-time mixed reality interaction. The user device 104 captures sensory and contextual information from the physical environment. The sensory and contextual information includes at least illumination, depth, and user input data. The network 106 transmits the captured information to the system 108 with low latency. The system 108 refers to a backend processing system or a server-based device. The system 108 analyses the captured information and generates the harmonized mixed reality content. Accordingly, the system 108 relays corresponding rendering parameters or visual updates back to the user device 104 through the network 106. The cooperative operation ensures temporal synchronization, contextual consistency, and seamless integration between physical and virtual components of the mixed reality experience.

Further, the system 108 is configured to coordinate, manage, and support the delivery of mixed reality (MR) content to the user device 104. The system 108 includes one or more computing devices configured to manage backend operations. The backend operations include, but are not limited to, processing user requests, storing and updating mixed reality content modules, harmonizing the digital objects, and executing rendering operations. In addition, the system 108 manages user sessions and maintains communication with the user device 104. The system 108 includes application programming interfaces (APIs), load-balancing modules, analytics engines, and orchestration logic to dynamically coordinate the mixed reality experiences across users and devices. Further, the system 108 manages user sessions, performs computational operations such as spatial computation, scene understanding, and mixed reality content personalization. Accordingly, the system 108 delivers contextually relevant mixed reality assets to client-side components.

In an embodiment of the present disclosure, the system 108 is associated with one or more remote computing entities. The one or more computing entities facilitate core services required for managing and supporting the mixed reality experiences. The system 108 operates as an orchestrator that communicates with the user device 104 over the network 106. In one example, the system 108 hosts APIs, decision engines, and application services configured to process user interactions, manage mixed reality session states and authenticate user access. In addition, the system 108 delivers relevant mixed reality content modules to downstream components. In certain implementations, the system 108 enforces access controls, implements deployment policies, and manages caching of frequently accessed mixed reality assets. Accordingly, the system 108 enhances responsiveness and delivery speed of the mixed reality content.

In an embodiment of the present disclosure, the system 108 represents architecturally distinct yet interoperable components of the interactive computing environment 100. Each instance of the system 108 is configured to perform complementary functions in support of the mixed reality content delivery and interaction. In some embodiments, the system 108 may be operatively coupled with a remote server configured to perform cloud-assisted computation, large-scale data processing, or model inference for the harmonization and the rendering tasks. The server may host backend services. In an embodiment, the backend services may include lighting estimation models, environmental context analyzers, or asset retrieval engines. The backend services augment the local processing performed by the system 108.

In another embodiment, the system 108 may be implemented as a server-based framework. The server-based framework includes distributed microservices that execute the harmonization logic, manage mixed reality sessions, and coordinate the user interactions across multiple devices. The server-based implementation allows high-performance rendering of the mixed reality content and persistent data storage. Also, the server-based implementation enables real-time synchronization for multiple concurrent users operating within shared mixed reality environments.

In yet another embodiment, a local instance of the system 108 and the server-based implementation operate in a cooperative and adaptive configuration. The configuration enables continuity of user experience across varying hardware and network conditions. In an example implementation, the local instance of the system 108 may execute time-critical rendering operations to ensure low-latency interaction. Also, the local instance of the system 108 performs immediate environment sensing, preliminary harmonization, and on-device rendering. The server communicates with the local instance of the system 108 to execute computationally intensive tasks such as deep learning inference. The computationally intensive tasks may include large-scale lighting prediction, data caching, multi-user scene synchronization, and the like. The distributed architecture enables scalability for diverse deployment scenarios. The deployment scenarios may range from standalone user experiences on handheld devices to multi-user collaborative mixed reality sessions managed over cloud infrastructure. Accordingly, the distributed architecture ensures balanced performance, resource efficiency, and visual coherence across both local and network-assisted execution modes.

In certain embodiments, the system 108 acts as an external host, and the database 120 may be integrated within the system 108. In alternative embodiments, the system 108 may operate as a server-based deployment in which the harmonization framework 114 and the database 120 are co-located within a unified computational environment. The arrangement provides tight coupling between the rendering logic and the backend data storage. Also, the arrangement enables rapid access to illumination parameters and harmonization datasets. The system 108 may retrieve and transmit harmonization assets such as relighting coefficients, environmental templates, and residual correction models. The harmonization assets support real-time alignment of the virtual objects with the physical lighting conditions across varying ambient environments.

In an embodiment, the system 108 functions as a backend orchestrator and processing layer, implemented using centralized or distributed server-class resources. The system 108 manages session states, executes computational operations such as spatial computation and scene analysis, and personalizes the mixed reality content. Also, the system 108 transmits context-aware mixed reality assets to client-side rendering components. In some embodiments, the system 108 serves as an edge computing or localized processing layer that interfaces directly with the user device 104. The system 108 is configured to handle real-time operations. The real-time operations include adaptive user interface control, haptic feedback coordination, sensor data ingestion, and latency-sensitive harmonized mixed reality content rendering.

The system 108 may include one or more processors, a non-transitory memory. In addition, the system 108 may include rendering and harmonization modules configured to generate and transmit the harmonized mixed reality content to the user device 104. The harmonization modules may utilize lighting analysis, color distribution data, and pixel-level feature extraction to adaptively align the digital objects with real-world illumination conditions. In certain implementations, the system 108 may host an intelligent orchestration layer. The orchestration layer manages module activation, data prioritization, and rendering sequence based on contextual factors. The contextual factor include but may not be limited to scene complexity or ambient lighting dynamics.

Further, the system 108 may include a real-time rendering engine capable of handling shading, occlusion, and reflection mapping. The rendering engine ensures that the harmonized digital elements blend seamlessly into the user’s physical environment. In an example, the system 108 may be implemented locally within the user device 104 for on-device rendering, or distributed across cloud servers to leverage high-performance computation for large-scale or collaborative mixed reality applications.

The system 108 plays a key role in mediating communication between the modular mixed reality engine 110 on the user device 104 and the backend infrastructure. The modular mixed reality engine 110 includes a plurality of mixed reality modules 112. The system 108 hosts, manages, and remotely executes an instant application mechanism. The instant application mechanism enables the dynamic delivery of the plurality of mixed reality modules 112 and ensuring platform- and device-independent user experiences.

The system 108 hosts a modular mixed reality engine 110 configured to execute and manage rendering operations associated with the harmonized mixed reality content. The modular mixed reality engine 110 refers to a software–hardware hybrid framework designed to dynamically load, execute, and unload modular components. The modular components are responsible for rendering, interaction, and environmental adaptation. In addition, the modular mixed reality engine 110 operates in a containerized or sandboxed environment. The sandboxed environment ensures secure, efficient, and isolated execution of each mixed reality module. In one embodiment, the modular mixed reality engine 110 establishes bidirectional communication with the user device 104. The bidirectional communication enables the modular mixed reality engine 110 to process real-time sensor inputs, perform content harmonization, and update rendered outputs with minimal latency. The system 108 ensures synchronized data exchange and resource orchestration across networked environments.

The modular mixed reality engine 110 includes a plurality of mixed reality modules 112. Each of the plurality of mixed reality modules 112 is configured to perform a distinct operational function. The plurality of mixed reality modules 112 may include, but are not limited to, lighting analysis modules, object rendering modules, spatial mapping modules, and gesture or voice recognition modules. Each of the plurality of mixed reality module 112 is independently deployable and interoperable. The independent deployment and interoperability enable dynamic scalability and efficient utilization of device resources. In an embodiment, the plurality of mixed reality modules 112 communicate through a standardized interface layer to allow seamless cross-module interaction and integration of multi-sensory data streams.

Further, the system 108 hosts, manages, and remotely executes an instant application mechanism configured to facilitate dynamic and on-demand delivery of the plurality of mixed reality modules 112. The instant application mechanism refers to a deployment and execution framework that allows users to access mixed reality content instantly without requiring full installation of the underlying application. The instant application mechanism enables lightweight runtime initialization of modular components through progressive data streaming, remote asset loading, or pre-fetching of high-priority modules. In an embodiment, the instant application mechanism operates through a secure runtime container. The runtime container supports differential updates, modular dependency resolution, and version management to ensure consistent operation across heterogeneous platforms. The mechanism ensures platform- and device-independent user experiences by abstracting hardware variations and adapting runtime parameters based on device capability, network conditions, and environmental complexity.

In some embodiments, the instant application mechanism utilizes adaptive streaming logic to determine an execution mode for the plurality of mixed reality modules 112. The execution mode includes the determination of whether the plurality of mixed reality modules 112 are executed locally on the user device 104 or offloaded to the system 108 for remote computation. The selective deployment reduces device-side computation load and subsequent maintenance of real-time responsiveness. The combination of the modular mixed reality engine 110, the plurality of mixed reality modules 112, and the instant application mechanism provides an extensible architecture. The architecture enables scalable, adaptive, and harmonized mixed reality rendering across diverse hardware ecosystems.

The system 108 enables seamless synchronization and dynamic loading of a plurality of mixed reality modules 112 across heterogeneous client platforms. The plurality of mixed reality modules 112 may include an environment mapping module, a spatial alignment module, a motion-tracking module, and an occlusion-handling module. The modular mixed reality engine 110 dynamically loads at least one module of the plurality of mixed reality modules 112 in real time, based on user interactions and environmental parameters derived from the captured image. The dynamic module loading enables the system 108 to apply appropriate harmonization techniques. The harmonization techniques include lighting adjustment, color consistency, or saturation correction and the like. The harmonization techniques ensure optimized system performance. In addition, the harmonization techniques enhance visual coherence of the digital objects with the physical environment. In an implementation, the modular mixed reality engine 110 may be platform-agnostic and modular in architecture. The modular architecture enables flexible deployment across diverse device types.

In another embodiment of the present disclosure, the modular mixed reality engine 110 dynamically unloads at least one module of the plurality of mixed reality modules 112 in real time. The unloading is based at least on user interactions or environmental lighting conditions. The orchestration of the loading and the unloading ensures efficient utilization of device resources, reduced latency, and improved continuity of the mixed reality experience. Subsequently, the orchestration ensures continuous harmonization of the digital objects with the lighting conditions of the physical environment.

The plurality of mixed reality modules 112 may operate within a kernel-level application sandbox or a secure sandbox environment in a Linux-based system to ensure security and efficiency. In one embodiment, the secure sandbox environment is enabled through context-aware permission management and a secure execution framework. The sandboxing ensures both stability and protection of system resources. Also, the sandboxing the harmonization of the digital objects and the rendering of the harmonized mixed reality content that adapts to the lighting conditions in real time.

In an embodiment of the present disclosure, the system 108 enables adaptive data streaming to adjust streaming rates based on network conditions and device performance. Also, the system 108 enables integration of edge computing capabilities for enhanced efficiency. Further, the system 108 may enable cross-module communication between at least two modules of the plurality of mixed reality modules 112 to facilitate real-time data exchange. The cross-module communication supports seamless blending of pixel-level adjustments. The pixel-level adjustments include but may not be limited to lighting alignment, color consistency, or saturation correction, with 3D environment mapping. Accordingly, the pixel-level adjustments enhance the realism and the visual coherence of the harmonized and rendered mixed reality experience.

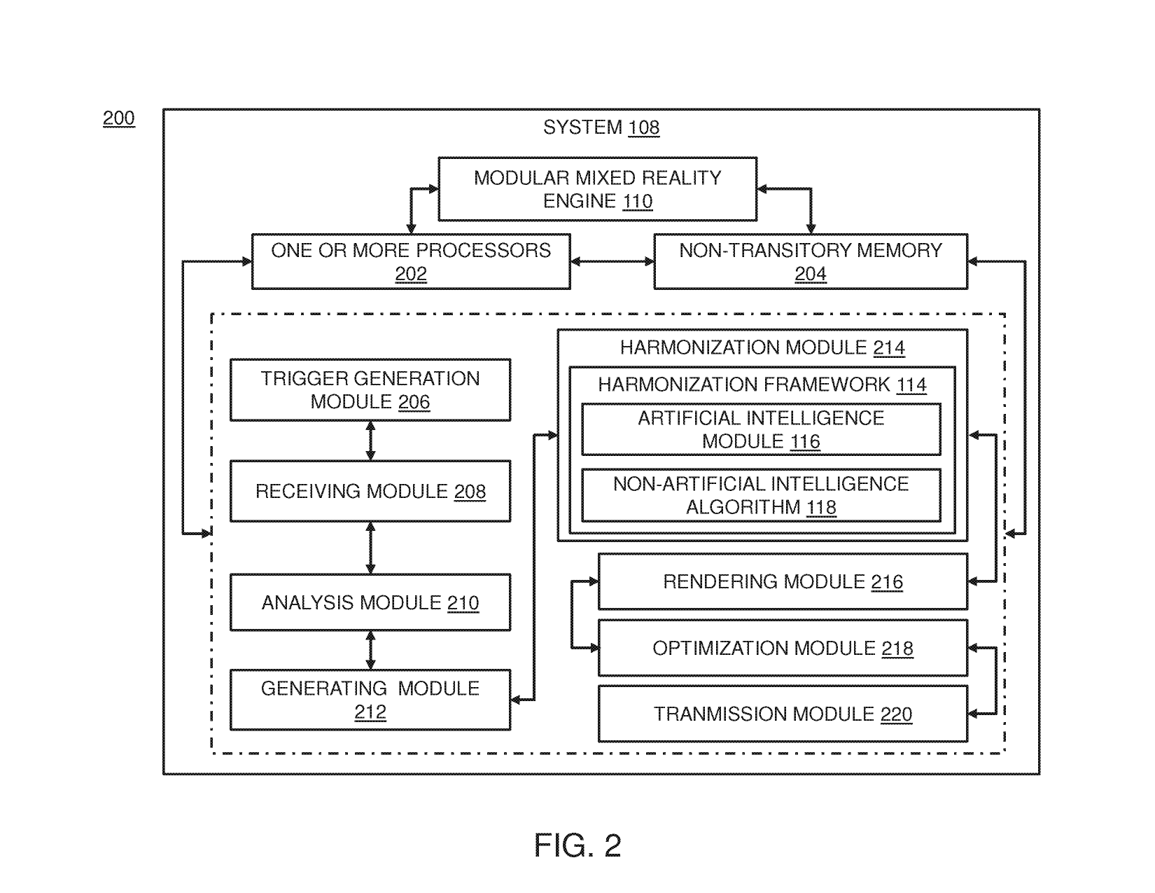

The user device 104 works in conjunction with the modular mixed reality engine 110 to perform a set of functions. The functions include receiving contextual image data, dynamically loading appropriate mixed reality modules 112, and applying harmonization data for lighting and color corrections. In addition, the functions include rendering immersive mixed reality content responsive to real-time user interactions and environmental conditions (as further detailed in the description of FIG. 2).

Going further, the system 108 includes a harmonization framework 114. The harmonization framework 114 orchestrates the application of the harmonization logic to the digital objects. The harmonization framework 114 orchestrates the application of the harmonization logic to at least one digital object. In an embodiment, there may be a single digital object or multiple digital objects harmonized and rendered in real time during the mixed reality experience. The integration of the multiple digital objects may depend at least on a type of mixed reality experience, a user input, and variations in sensor input, or a combination thereof.

In an embodiment, the harmonization framework 114 may execute switching-based harmonization of the plurality of digital objects on a real time, dynamic and adaptive basis. The switching-based harmonization refers to a selective transfer of harmonization focus or processing priority from one digital object to another within a shared mixed reality scene. In an embodiment, the switching may occur automatically based on contextual or environmental parameters detected by the system 108. In an example, when multiple digital objects coexist within the same frame, the harmonization framework 114 may dynamically determine which object requires immediate rebalancing of lighting or color adaptation based on a relative visual prominence. The switching process ensures that the system resources are optimally allocated. In addition, the switching ensures that each digital object retains photometric consistency with the surrounding physical environment.

The contextual parameters may include relative object proximity, object luminance contrast, or dynamic changes in environmental illumination. For example, when multiple digital objects are rendered within overlapping fields of view, the harmonization framework 114 may prioritize the object nearest to the dominant light source for recalibration. In another example, the switching may occur when an object’s material property, such as reflectivity or transparency, exhibits a higher deviation from the estimated lighting model compared to other objects in the scene. In an embodiment, additional factors influencing the switching include user focus or gaze direction, depth ordering of virtual elements, and sensor-detected variations in ambient color temperature. The harmonization framework 114 dynamically evaluates the contextual or environmental parameters to determine whether continuous or selective harmonization is required. In addition, the harmonization framework 114 ensures each digital object maintains realistic appearance and consistent integration with the physical environment.

The harmonization framework 114 may manage the switching operations through an adaptive control layer. The control layer is configured to maintain temporal smoothness and computational stability during transitions between the plurality of digital objects. In one embodiment, the framework pre-computes the harmonization data for multiple active digital objects and stores them in a transient cache to enable instantaneous retrieval during the switching. The cached harmonization parameters may include illumination matrices, tone-mapping coefficients, and reflection-response maps that correspond to individual objects.

The harmonization framework 114 may apply an interpolation mechanism that gradually blends lighting coefficients from an outgoing object to an incoming object to prevent abrupt visual changes. In some implementations, the harmonization framework 114 utilizes a priority-based scheduler. The priority-based scheduler allocates GPU or neural inference resources to the most visually dominant object within the user’s current field of view. The scheduler dynamically reassigns computational resources based on factors such as scene complexity, user interaction rate, and real-time frame rendering latency. The dynamic reassignment ensures that the switching-based harmonization maintains perceptual continuity and optimized system performance.

The system 108 may refine output generated by the harmonization framework 114. In addition, the system 108 may continuously evaluate harmonization accuracy and rendering efficiency. Further, the system 108 includes one or more modules which monitor factors such as illumination drift, color balance deviation, and frame latency. Accordingly, the one or more modules determine whether re-harmonization or resource reallocation for the plurality of digital objects is required. In an embodiment, the one or more modules dynamically adjust texture resolution, shader complexity, or lighting precision parameters based on system load and environmental variation. The combined operation of the harmonization framework 114 and the one or more modules enables an adaptive rendering pipeline. The rendering pipeline is capable of sustaining perceptual consistency, high frame stability, and efficient utilization of hardware resources across diverse lighting and interaction conditions

In an embodiment, the harmonization framework 114 manages the switching operations through an internal buffering and synchronization layer configured to minimize transition latency. The internal buffering layer refers to a temporary data storage mechanism configured to hold harmonization parameters during object transitions. The internal buffering ensures uninterrupted data access and minimal processing delay. The synchronization layer refers to a timing control component that aligns operations across different processing modules to maintain consistent frame sequencing and temporal coherence during rendering.

The harmonization framework 114 maintains a harmonization buffer. The buffer is a dedicated memory segment used for storing pre-computed illumination and tone adaptation parameters for each active digital object. The stored parameters include at least luminance coefficients, color temperature correction factors, and object-specific exposure matrices. The luminance coefficients define a proportional intensity of light reflected from an object surface relative to incident illumination. The correction factors compensate for shifts in hue and brightness caused by varying light sources or environmental color tones. The object-specific exposure matrices define per-object brightness scaling functions ensuring that dynamic range and visual contrast remain perceptually accurate under fluctuating lighting conditions.

In another embodiment, the harmonization framework 114 may perform selective harmonization of at least one digital object of a plurality of digital objects in real time. The selective harmonization refers to a capability of the harmonization framework 114 to identify and prioritize specific digital objects for illumination or color adjustment. The priority is determined based on contextual parameters of the physical environment. The contextual parameters may include ambient brightness, object prominence, user focus, or scene composition metadata. For example, when multiple digital elements are simultaneously rendered in a shared scene, the harmonization framework 114 selectively applies lighting and tonal corrections to only those objects that exhibit perceptible deviations from the real-world illumination profile. The selective operation reduces computational load and, subsequently preserves visual consistency across the mixed reality scene.

During a switching event, the harmonization framework 114 retrieves the cached parameters of the next object in the rendering sequence and applies interpolation-based blending. The interpolation-based blending refers to a gradual merging technique that linearly or non-linearly combines illumination parameters of consecutive digital objects. Accordingly, the combining enables production of seamless visual continuity during frame transitions. The synchronization layer coordinates timing between one or more modules configured for rendering optimization.

In some embodiments, predictive switching logic is employed to anticipate upcoming transitions based on motion trajectory, user gaze direction, or environmental lighting drift. The predictive switching logic refers to an adaptive algorithmic framework that uses temporal and spatial data to pre-emptively compute the next harmonization state before a visual transition occurs. The motion trajectory refers to a spatiotemporal path representing a direction and velocity of an object or the user’s viewpoint in three-dimensional space. The user gaze direction refers to an estimated vector of the user’s attention or visual focus determined from head tracking, eye tracking, or positional sensors. The environmental lighting drift refers to gradual or abrupt variations in brightness, hue, or color temperature within the physical environment over time. The above mentioned predictive mechanisms enable near-zero latency switching and continuous visual coherence in complex mixed reality scenes containing multiple dynamically illuminated digital objects.

The harmonization framework 114 communicates the computed harmonization parameters to the system 108 through an internal rendering interface. The rendering interface is configured to transmit illumination, tone, and texture adjustment data in real time. In addition, the rendering interface refers to a data transmission layer within the system 108 that converts the harmonization parameters into rendering instructions compatible with multiple display and processing devices. In an embodiment, the harmonization framework 114 interacts with device-side rendering components associated with the user device 104. The interaction is done to apply lighting corrections, and texture modulation to digital objects. The continuous exchange of the harmonization data ensures that the rendered content on the user device 104 remains visually coherent with the lighting dynamics of the surrounding physical environment. In another embodiment, the harmonization framework 114 employs the predictive data buffering and time-stamped synchronization. The buffering and synchronization techniques ensure timely delivery of lighting updates in temporal alignment with frame rendering. Accordingly, the harmonization framework 114 prevents perceptible lag or mismatch between digital illumination and the physical scene.

The harmonization framework 114 refers to a processing layer within the system 108 configured to manage operations relating to the alignment of the digital objects with the physical environment. The harmonization framework 114 may include software libraries, runtime services, or hardware-accelerated components that perform generic harmonization tasks. In one example, the harmonization framework 114 may be configured as a containerized service running on edge devices or cloud servers to ensure scalability across deployment environments. In another example, the harmonization framework 114 may be implemented as an on-device runtime library optimized for resource-constrained devices such as smartphones, tablets, or wearable displays. The harmonization framework 114 may provide standardized interfaces or application programming interfaces (APIs) that expose functions for data ingestion, pre-processing, and adjustment of rendering parameters.

The harmonization framework 114 includes an artificial intelligence module 116 and a non-artificial intelligence algorithm 118. The artificial intelligence module 116 broadly refers to computational models trained on large datasets for learning lighting patterns, color consistency rules, and pixel-level corrections in visual environments. The artificial intelligence module 116 may include neural networks configured for pixel-consistency transformation, dual-color harmonization, saturation estimation, or diffusion-based relighting. In addition, the artificial intelligence module 116 may adapt to novel environments by leveraging transfer learning or incremental training updates.

The non-artificial intelligence algorithm 118 refers to deterministic models and rule-based techniques used for harmonization when computational efficiency or predictability is prioritized. Examples include histogram equalization, rule-based saturation correction, color temperature alignment, or background MixNMatch correction pipelines. The non-artificial intelligence algorithm 118 may be deployed in scenarios requiring lightweight computation or when device resources limit the execution of heavy machine learning models. In some implementations, the harmonization framework 114 dynamically switches between the artificial intelligence module 116 and the non-artificial intelligence algorithm 118. The switching is based on device capability, environmental complexity, or latency requirements.

In an example implementation of a distributed computing environment, the system 108 is operatively connected to a server-based device, referred to herein as the system 108. The system 108 includes or is operatively coupled to the database 120. In another implementation, the system 108 includes or is operatively connected to the database 120 for storing localized content or cached user session data. The system 108 may act as a cloud or edge host in distributed configurations. The system 108 provides storage and computation for the real-time harmonization. The system 108 handles client requests, updates the plurality of mixed reality modules 112, and provides the harmonization data for alignment of the at least one digital object with the environmental lighting conditions.

The system 108 includes software components, processing units, and virtualized services designed to manage tasks. The tasks include module selection, compatibility evaluation, mixed reality asset delivery, and spatial computation. In some embodiments, the system 108 represents a cloud-based platform, an edge computing node, or a centralized rendering hub. The system 108 may incorporate high-performance computing resources configured for executing the harmonization operations. The operations may include image pre-processing, feature extraction, relighting model inference, and post-processing for final rendering. Additional functions may include multi-threaded scheduling for concurrent module execution, and GPU-accelerated pipelines for the pixel-level harmonization. Also, the functions may include the fallback mechanisms to the non-AI algorithms 118 in cases of resource limitations.

The database 120 refers to one or more persistent storage systems configured to maintain real-time and historical data relevant to mixed reality harmonization. The database 120 may include repositories of mixed reality modules, user-specific interaction logs, device configuration profiles, pre-trained artificial intelligence models, and environmental context data such as lighting distributions and HDRi maps. The database 120 supports efficient synchronization of data to enable dynamic selection and deployment of harmonization modules in response to real-time environmental analysis. The database 120 may be implemented as a distributed cloud database, a hybrid storage solution, or a federated architecture for ensuring scalability, redundancy, and low-latency access.

The database 120 may include relational or non-relational storage models, such as SQL databases, NoSQL stores, graph databases, or in-memory databases for high-speed access. In some implementations, graph-based indexing may be used to represent relationships between lighting parameters, object placement contexts, and harmonization models, allowing for accelerated query resolution during real-time rendering.

In certain embodiments, the system 108 acts as an external host and the database 120 may be integrated within the system 108. In alternative embodiments, the system 108 may host the database 120 within a unified deployment environment, providing tight coupling between rendering logic and backend data storage. The system 108 may retrieve and transmit harmonization assets such as relighting coefficients, environmental templates, and residual correction models for enabling real-time alignment of virtual objects with physical lighting conditions.

While FIG. 1 illustrates a single user 102 interacting with the single user device 104, multiple users may simultaneously interact with corresponding devices. Each device can independently execute the harmonization operations and share the contextual parameters such as the lighting maps and the environmental constraints with the system 108.

The number and arrangement of systems, devices, and networks shown in FIG. 1 are provided merely as an example. Additional systems and devices may be included, fewer may be deployed, or arrangements may vary depending on implementation scenarios. For instance, a set of devices may assume the functions of another set of devices, or a single device may be distributed across multiple processing entities. Such flexibility enables the interactive computing environment 100 to scale across mobile devices, AR glasses, tablets, or server-driven mixed reality sessions.

Beyond the above configurations, the system 108 is operable to execute the harmonization pipelines that integrate sensor fusion data streams with lighting estimation models. In one embodiment, RGB camera data is fused with HDRi maps and depth sensor information to generate pixel-level harmonization parameters. The fusion process enhances realism by aligning object shading, color temperature, and brightness with the actual physical environment. The system 108 may include fallback mechanisms. The fallback mechanisms include an AI-based harmonization model such as PCTNet or DucoNet. The fallback mechanisms dynamically switch to the non-AI algorithms 118 for baseline relighting when device resources fall below a threshold.

The system 108 may employ GPU shaders to accelerate photometric harmonization. The GPU shaders enable execution of tasks such as histogram-based reweighting of luminance and chrominance, saturation normalization, and perspective correction. In distributed deployments, the system 108 may host heavy inference models. Simultaneously, the user device 104 executes lightweight harmonization tasks locally.

In advanced implementations, the database 120 supports multi-user harmonization consistency by maintaining global photometric profiles for shared environments. The global profiles ensure that when multiple users interact within the same mixed reality session, virtual objects appear consistently harmonized across all devices. Further, the system 108 can integrate predictive correction models to anticipate changes in lighting, such as flicker from artificial sources or shadow displacement.

FIG. 2 illustrates a block diagram 200 of the system 108 for harmonizing the at least one digital object with the lighting conditions of the physical environment in real time, in accordance with various embodiments of the present disclosure.

The system 108 includes one or more processors 202 operatively coupled to a non-transitory memory 204. The non-transitory memory 204 stores program instructions. The one or more processors 202 execute the program instructions. The program instructions direct the system 108 to analyze the image data captured by the one or more sensors 104a of the user device 104. In addition, the program instructions direct the system 108 to generate the harmonization data, and render the visually coherent digital objects through the modular mixed reality engine 110. In order to explain the system elements of FIG. 2, references will be made to the elements of FIG. 1 for clarity and ease of understanding.

The system 108 includes a modular processing pipeline executed by the one or more processors 202. The one or more processors 202 execute the modular processing pipeline using program instructions stored in the memory 204. The modular processing pipeline includes a plurality of system modules configured to execute a unique functional process in a logically sequential manner. The plurality of system modules include a trigger generation module 206, a receiving module 208, an analysis module 210, a generating module 212 and a harmonization module 214. In addition, the plurality of system modules include a rendering module 216, an optimization module 218, and a transmission module 220. It should be noted that the above-mentioned system elements are exemplary and non-limiting; additional or alternative elements may also be incorporated within the system 108 in other implementations.

The plurality of system modules are operatively coupled in a sequential and feedback-driven architecture. Each module of the plurality of system modules produce outputs that serve as standardized inputs for subsequent modules of the plurality of system modules. The plurality of system modules are configured to interact with each other to establish a structured workflow for the harmonization of the digital objects with the physical environment. The block diagram 200 illustrates the plurality of system modules as part of the system 108. However, additional modules may be included in the modular processing pipeline depending on deployment requirements or specific harmonization scenarios.

The interaction between the plurality of system modules forms a continuous data flow within the modular processing pipeline of the system 108. The plurality of system modules are collectively configured to capture sensor inputs from the user device 104. Accordingly, the plurality of system modules contextualize, analyse, and translate the captured sensor inputs into actionable harmonization data. Each system module executes a specialized function, and concurrently exposes standardized outputs to downstream modules through well-defined interfaces. The modular approach ensures seamless integration, extensibility of components, and low-latency data transfer across the pipeline.

The elements of the system 108 described herein are operatively coupled to enable end-to-end harmonization of the at least one digital object with the physical environment. The one or more processors 202 orchestrate the operation of the system modules by executing the program instructions stored in the non-transitory memory 204. The execution flow begins with reception of sensor data and triggering inputs from the user device 104. The execution flow proceeds through analytical and harmonization stages, and culminates in rendering and optimization of the visually coherent mixed-reality content. Each module in the architecture is configured to operate either independently or cooperatively with adjacent modules. The mode of operation depends on runtime conditions, resource availability, and environmental complexity.

The memory 204 stores instructions that, when executed, cause the processor 202 to perform dynamic and adaptive rendering of the mixed reality (MR) content based on one or more inputs from the camera module in real time. The processor 202 is operably coupled with the modular mixed reality engine 110, the trigger generation module 206, the detection module 208, the activation module 210, the receiving module 212, and the context recognition module 214. Additionally, the processor 202 is in communication with the loading module 218, the rendering module 220, and the optimization module 222.

The elements of the system 108 collectively operate in synchronization to enable the user 102 to access and interact with the mixed reality experience. The mixed reality experience is deployed within a distributed computing environment. The distributed computing environment includes the user device 104, a local execution system integrated with the modular mixed reality engine 110, and the server operably coupled with the database 120. The system 108 executes within a transient runtime on the user device 104. In addition, the system 108 is configured to selectively render mixed reality content based on metadata and execution of one or more instructions. The system 108 receives the one or more instructions from the server in response to one or more triggering actions generated at the trigger generation module 206.

The non-transitory memory 204 stores instructions that are executed by the one or more processors 202. Upon the execution of the instructions, the one or more processor 202 cause the system 108 to perform a series of operations for enabling the harmonized mixed reality rendering. The harmonization refers to the process of aligning the at least one digital object with the lighting conditions or characteristics. The at least one digital object may include three-dimensional (3D) models, textures, animations, or graphical overlays. The lighting conditions or characteristics include but may not be limited to illumination, and color balance of the surrounding physical environment. The harmonization transforms or manipulates the at least one digital object to appear naturally integrated and visually coherent with real-world content.

The trigger generation module 206 is configured to generate one or more triggering actions for initiating the harmonization process. The triggering actions may include scannable code activation, gesture input, voice command, or selection of a digital interface element rendered on the user device 104. In operation, the trigger generation module 206 detects a user-initiated event through a camera module of the user device 104. Accordingly, the trigger generation module 206 generates a standardized trigger signal corresponding to the user-initiated event. The trigger signal instructs the system 108 to begin data acquisition and execute the harmonization process.

The trigger generation module 206 generates the trigger signal upon detection of a user response to the triggering action. The trigger signal generation enables initiation of sensor data acquisition and the harmonization sequence execution by the system 108. The user response refers to an intentional or system-recognized interaction indicating user consent or engagement for initiating a mixed reality session. The user response may include an explicit action such as tapping an interface element, pressing a virtual or physical activation button, issuing a voice command, or performing a recognized gesture within the camera field of view. In another example, the user response may include an implicit action such as aligning the device 104 toward a detected surface or environmental marker. The trigger generation module 206 interprets the user response using event listeners or sensor-based feedback mechanisms.

In an embodiment, the trigger generation module 206 may generate access triggers such as an image trigger, a video trigger, or a link-based trigger. Each access trigger is mapped to a preconfigured initiation workflow. In another embodiment, the trigger generation module 206 may generate universal triggers compatible across heterogeneous device platforms and operating systems. The universal access triggers ensure interoperability of the mixed reality experiences. The trigger generation module 206 may employ low-latency event listeners or embedded sensor-monitoring routines to detect the one or more triggering actions in real time without perceptible delay. Accordingly, the trigger generation module 206 establishes an initial entry point for system-level harmonization operations. The trigger generation module 206 ensures that subsequent modules of the modular processing pipeline receive validated initiation signals for data acquisition and analysis.

Each of the plurality of triggering actions provides a mechanism for the user 102 to initiate access to the mixed reality content on the user device 104. The triggering actions enable device-agnostic and platform-agnostic access to the mixed reality content. The triggering actions support interoperability across heterogeneous devices without requiring device-specific configurations. In an embodiment, detecting a hyperlink selection or scanning a scannable code on the user device 104 initiates loading of the metadata linked to the harmonization experience. The metadata may include at least one of an experience identifier, lighting-calibration parameters, or asset locations corresponding to the at least one digital object to be harmonized.

In another embodiment, detection of a near-field communication (NFC) tag by the user device 104 includes establishing an NFC session, and retrieving encoded harmonization data. Accordingly, the detection process through NFC includes transmitting the retrieved data to the system 108 to activate the lighting-analysis and harmonization modules. Each triggering action may be associated with a universal access link compatible with hardware capabilities of the user device 104 and the current environmental context. The triggering actions enable automatic configuration of the one or more sensors 104a and harmonization settings.

For example, a QR code affixed near a physical object may be scanned by a user to initiate harmonization of a corresponding digital twin of the physical object. Upon scanning, the receiving module 208 acquires the captured image of the physical scene, decodes embedded metadata, and transmits the information to the system 108. Accordingly, the system 108 executes illumination analysis and harmonization data generation. The illumination analysis and the generation of the harmonization data allows users to experience lighting-accurate digital augmentations without manually calibrating associated devices.

The one or more processors 202, using the receiving module 208, receives one or more images of the physical environment captured by the one or more sensors 104a. The one or more sensors integrated within the user device 104. The one or more sensors 104a may include at least a camera module, a depth sensor, or a multi-spectral imaging unit configured to capture environmental visual information. In some embodiments, the camera module may capture a single image frame, a burst sequence, or a video stream of the physical environment depending on a type of mixed reality experience to be rendered.

For example, a smartphone equipped with an RGB camera and a depth sensor may capture both two-dimensional (2D) color information and three-dimensional (3D) spatial depth information of a scene such as a living room illuminated by natural sunlight. In another example, a head-mounted display (HMD) may capture a sequence of environmental frames while a user moves through a physical space for enabling continuous environmental lighting analysis. The receiving module 208 pre-processes the captured image data through operations such as noise reduction, exposure normalization, and contrast balancing to prepare the input data for accurate environmental parameter extraction.

The one or more processors 202, using the analysis module 210, execute analysis of the received one or more images to derive one or more environmental parameters. The one or more environmental parameters are representative of lighting and color characteristics of the physical environment. The analysis may include estimating brightness gradients, determining light source orientation, computing average color temperature, and assessing the overall luminance and chrominance distribution.

The one or more environmental parameters may include a High Dynamic Range image (HDRi) environment map. The High Dynamic Range image (HDRi) environment map represents scene illumination intensities. In addition, the one or more environmental parameters may include a CubeMap. CubeMap encodes a six-directional light capture of the scene, a global brightness value indicative of exposure, and a color temperature metric. The color temperature metric characterizes a spectral warmth or coolness of the ambient light. For instance, an indoor fluorescent-lit room may produce a color temperature of around 4200K, while sunlight at noon may register around 5600K.

Further, the analysis module 210 performs feature extraction on the received one or more images data to identify light-emitting regions, reflective surfaces, and shadow boundaries. The features collectively define how digital light interacts with the physical environment. In one embodiment, the analysis is performed using histogram-based color clustering, gradient mapping, or illumination vector estimation methods. In another embodiment, artificial intelligence models such as convolutional neural networks trained for light source detection are utilized to infer spatially varying illumination properties.

For example, when a user scans a tabletop under diffused daylight, the system 108 may extract an HDRi map that encodes color shifts caused by ambient light. Conversely, when the environment includes directional lighting such as spotlights or lamps, the CubeMap and the color distribution parameters capture high-contrast regions necessary for accurate digital object shading.

Going further, the one or more processors 202, using the generating module 212, generate the harmonization data based on the one or more environmental parameters. The harmonization data includes one or more adjustment values that define how the at least one digital object should be visually modified to match the lighting and color context of the physical environment. The adjustments may include lighting alignment, color consistency, saturation calibration, or perspective scaling.

In one embodiment, the lighting alignment refers to modifying the virtual object’s shading, and highlights, to correspond to the dominant light direction in the physical environment. For example, if the real environment exhibits a light source on the right-hand side of the frame, the digital object’s virtual light shader is reoriented accordingly. The color consistency refers to aligning the hue, saturation, and intensity distributions of the at least one digital object with the background color characteristics of the received image. For example, a virtual chair rendered in a daylight scene adopts subtle blue hues consistent with ambient illumination.

The saturation adjustment ensures that the at least one digital object appears naturally vivid and excessively unmuted relative to the physical environment surroundings. The perspective scaling refers to adjusting the object’s apparent depth and proportion relative to the physical background geometry to maintain visual realism. For instance, an augmented lamp rendered on a real table is scaled to match the table’s height and aligned to an associated vanishing point in the captured image.

The harmonization data is subsequently applied to the at least one digital object through the harmonization framework 114. In an embodiment, the pixel-level adjustment of the object’s luminance, color temperature, and saturation based on interpolation with environmental values. In another embodiment, the framework 114 applies the geometric transformations to ensure object-to-surface contact alignment. The adjustments may occur in real time as the user device 104 moves or as lighting conditions change.

For example, when a user walks from an indoor environment into outdoor sunlight, the harmonization framework 114 dynamically adjusts the digital object’s brightness and tone to remain consistent with the shifting illumination. Similarly, if the environment includes a transition from warm indoor light to cooler daylight, the harmonization framework 114 automatically performs adaptive color temperature correction to maintain perceptual realism.

The harmonization module 214 executes the harmonization framework 114. The one or more processors 202, using the harmonization module 214, apply the harmonization data to the at least one digital object. The harmonization modules 214 implements the harmonization process for enabling the transformation and the manipulation of the at least one digital object. The transformation and manipulation enable natural integration of the at least one digital object with a real-world content captured from the physical environment. In addition, the transformation and manipulation enable visual coherence between the at least one digital object and the real-world content captured from the physical environment. The transformation involves performing one or more visual and geometric adjustments that adapt the digital object to match at least real-world lighting, depth, and perspective conditions.

In an embodiment, the harmonization includes illumination matching, color temperature balancing, tone mapping, and the like. The illumination matching refers to adjusting the intensity, direction, and fall-off of virtual lighting applied to the at least one digital object. The adjustment is done so that the at least one digital object corresponds to illumination vectors detected in the physical environment. The color temperature balancing involves modifying hue and warmth characteristics of the digital object to align with the dominant color temperature of the environment’s light sources. The light sources may include warm indoor lighting or cool daylight. The tone mapping is defined as compressing or expanding a luminance range of the at least one digital object to maintain perceptual brightness and contrast within the dynamic range of the user device 104.

In some embodiments, the harmonization module 214 may perform reflected light simulation. The reflected light simulation corresponds to reproduction of indirect illumination and color bleeding effects from nearby physical objects onto the digital object. The process may include exposure compensation. The digital object’s brightness and contrast levels are adjusted to match camera exposure settings used for capturing the physical environment.

In an embodiment, the harmonization module 214 may apply geometric manipulations. The geometric manipulations include perspective warping, depth-based scaling, and occlusion-aware alignment. The perspective warping involves deforming or rotating the digital object geometry to preserve vanishing-point consistency with the captured scene. The depth-based scaling refers to adjusting a size of the at least one digital object according to depth or parallax information derived from scene mapping. The occlusion-aware alignment dynamically modifies the rendered object visibility based on detected real-world depth data. The transformations enable the harmonized digital object to seamlessly blend with the physical environment across varying lighting conditions, surface reflectance levels, and user viewpoints.

In an embodiment, the harmonization module 214 employ the artificial intelligence (AI) model 116 and the non-artificial intelligence (non-AI) algorithm 118 to perform the harmonization. The artificial intelligence (AI) model 116 (hereinafter, “AI model 116”) may include at least one of a pixel-consistency transformation network (PCTNet) and a dual-color harmonization network (DucoNet). In addition, the AI model 116 may include at least one of a saturation estimation model, or a diffusion-based relighting model. The AI models are configured to learn relationship between illumination features in the real-world environment and the lighting attributes of digital content. In addition, the AI models process multi-channel input data to compute adaptive harmonization parameters. The input data includes but may not be limited to RGB values, surface normals, depth maps, and estimated light directions

The non-AI algorithm 118 may include rule-based or mathematical methods, such as gradient-domain relighting, histogram equalization, and tone-mapping transformations. The non-AI algorithm 118 operates in deterministic fashion to adjust one or more visual characteristics of the digital object based on predefined illumination equations. In certain embodiments, the AI model 116 and the non-AI algorithm 118 operate in parallel. The non-AI algorithm 118may provide initial corrections and the AI model 116 refines perceptual coherence through learned residual mapping.

In another embodiment, the harmonization module 214 executes a residual correction process to minimize any visual discrepancy between the rendered digital object and the captured real-world scene. The residual correction involves receiving the rendered object output and the captured image of the physical environment, extracting pixel-level features, and generating corresponding feature maps. The pixel-level features may include luminance, chrominance, and saturation from the rendered object and the captured image. The harmonization module 214 compares the extracted pixel-level features to identify pixel regions with inconsistent lighting or color distribution.

The AI model 116 performs iterative fine-tuning by adjusting visual parameters of the rendered digital object, such as gamma, white balance, or hue. The fine-tuning is done to align appearance of the at least one digital object with the captured environment. The residual correction ensures that the harmonized digital content remains perceptually identical to the physical surroundings under complex and mixed lighting scenarios. The scenarios may include partially shaded environments or variable ambient illumination.

In an embodiment, the harmonization module 214 may implement a background MixNMatch algorithm for enhanced color and luminance alignment between the physical and digital layers. The background MixNMatch algorithm segments the background regions of the captured image, and extracts color and brightness profiles. Accordingly, the background MixNMatch algorithm compares the segmented background regions and the extracted color and brightness profiles with the harmonized digital object. The harmonization module 214 utilizes the comparison output and adjusts pixel values in the rendered output using luminance blending and chromatic reweighting functions to minimize discrepancies. For instance, in an outdoor scenario, the MixNMatch algorithm aligns the tone of a rendered signboard with sky gradient and ground reflection patterns captured by the camera to ensure coherent and physically accurate blending. The MixNMatch algorithm may serve as a post-harmonization alignment layer for reinforcing global color balance and perceptual uniformity across the composite MR frame.

Going further, the one or more processors 202, using the rendering module 216 render the harmonized digital object in real time using the modular mixed reality engine 110. The rendering module 214 integrates the harmonization parameters such as light direction vectors, tone curves, and color maps to generate the final composite frame. The rendered output reflects photometric alignment, and material and depth consistency. In addition, the system 108 maintains the fidelity of the digital object under dynamic viewing angles and environmental conditions.

The one or more processors 202, using the optimization module 216, dynamically optimize the rendered at least one digital object. The dynamic optimization is done based on characteristics extracted from the captured image of the physical environment. In addition, the dynamic optimization maintains the visual coherence of the rendered at least one digital object with the captured image. In addition, the dynamic optimization is done using at least one of the AI model 116 and the non-artificial intelligence algorithm 118. The optimization process involves real-time analysis of incoming camera frames to detect changes in lighting, exposure, or environmental context. Upon detecting variations, the optimization module 216 recalibrates the rendered object’s lighting coefficients and texture brightness using pixel intensity mapping.

The operation includes color correction. The color correction involves mapping of the pixel intensity values of the rendered digital object to the pixel intensity values of the captured physical environment. In addition, the optimization module 216 applies tone curves and gamma correction functions adaptively to maintain uniform brightness and color distribution.

In an embodiment, the color correction process includes adaptive reweighting of luminance and chrominance components based on histogram analysis of the physical environment image. The harmonization framework 114 computes histograms for luminance (Y) and chrominance (Cb, Cr) channels, derives dominant intensity clusters, and computes scaling coefficients. The coefficients reweight the digital object’s color components to preserve perceptual brightness and ensure chromatic consistency. For instance, in a sunset-lit environment, chrominance scaling enhances red tones to reflect warm lighting, while under artificial cool lighting, the balance shifts toward blue hues. The adaptive histogram-driven process maintains realistic color harmony across time and lighting transitions.

In some embodiments, the dynamic optimization may include an exposure balancing subroutine. The exposure balancing subroutine detects overexposed or underexposed regions within the rendered frame and adjusts local brightness and contrast values. For example, when a user moves from a dimly lit indoor area to a bright outdoor setting, the exposure balancing algorithm compensates for the sudden increase in ambient brightness by reducing the rendered object’s luminance to prevent visual saturation. Conversely, when the lighting dims, the rendered object’s brightness is adaptively enhanced to maintain visibility and realism.

In one embodiment, the dynamic optimization includes adaptive reweighting of luminance and chrominance components. The adaptive reweighting is based on histogram analysis of the captured image of the physical environment. The optimization module 216 decomposes the image into luminance (Y) and chrominance (Cb, Cr) channels and computes corresponding histograms. The histogram peaks represent dominant color and brightness levels of the physical environment. The optimization module 216 derives reweighting coefficients from the histograms and applies the reweighting coefficients to the luminance and chrominance components of the rendered digital object. The reweighting process enhances the perceptual alignment between the virtual and real-world components. The adaptive reweighting maintains consistent color balance even under rapidly changing illumination.

In another embodiment, the dynamic optimization process includes temporal filtering and motion-compensated stabilization to ensure smooth visual transitions during user or camera motion. The temporal filtering averages luminance and color adjustments across successive frames to prevent abrupt flicker or instability in the rendered object’s appearance. The motion-compensated stabilization employs optical flow estimation to predict motion vectors and adjust rendering parameters in synchronization with real-world camera motion.

In certain embodiments, the optimization module 216 employs artificial intelligence–based predictive optimization, using recurrent neural networks (RNNs) or temporal convolutional networks (TCNs). The recurrent neural networks (RNNs) or the temporal convolutional networks (TCNs) are trained to anticipate lighting changes based on motion trajectory, time-of-day metadata, or environmental sensor readings. The predictive optimization enables pre-emptive adjustment of the harmonization parameters to minimize latency in adaptation to lighting transitions.

In some embodiments, the dynamic optimization incorporates material-aware adjustments. The material-aware adjustment may include dynamic modification of reflectivity, roughness, or refractive index of a rendered digital object’s material based on the detected environment. For example, a rendered metallic object may exhibit stronger specular highlights under direct sunlight but reduced reflections under diffuse indoor lighting. The optimization module 218 retrieves material parameters from a harmonization database and applies adaptive shaders to replicate the context-specific visual effects.

In yet another embodiment, the dynamic optimization includes depth- and angle-dependent correction. The optimization module 218 evaluates parallax variations and viewing angles of the user device 104. Based on the parameters, the system 108 adjusts perspective distortion, and surface illumination gradients to preserve physical realism as the user’s viewpoint changes.

In some implementations, the dynamic optimization utilizes feedback from the harmonization module 214 to maintain consistency across frames. The harmonization module 214 provides real-time error metrics quantifying color drift, brightness deviation, or tone mismatch. The metrics are continuously fed to the optimization module 218, which recalibrates the harmonization parameters dynamically to achieve a perceptually stable and harmonized mixed reality output.

In an exemplary scenario, when a user interacts with a virtual object (for example, a digital sculpture) placed in a mixed reality scene during sunset, the optimization module 218 gradually reduces blue luminance components and enhances red–orange tones as ambient lighting shifts toward warmer hues. Simultaneously, the module re-adjusts shadow softness and reflection strength to maintain physical plausibility, resulting in a seamless visual transition consistent with the evolving real-world light.

In some embodiments, the dynamic optimization is partially offloaded to an edge-computing server integrated with the system 108. The server may perform computationally intensive operations such as histogram matching, HDR reconstruction, and neural model inference are processed on remote hardware. The optimized harmonization parameters are streamed back to the user device 104 at low latency. The distributed architecture enables high-quality real-time optimization even on devices with limited processing power

In an embodiment, the AI model 116 may perform predictive modelling to anticipate illumination or motion variations to pre-fetch the harmonization data before a visible change occurs. The feedback loop may consider motion vector estimates, user gaze tracking, and frame-based environmental differentials. Accordingly, the system 108 enables a smooth visual experience with near-zero latency during dynamic MR interactions.

In some embodiments, the system 108 employs alpha blending, transparency mapping, and optical flow-based temporal stabilization. The system 108 implements a final compositing stage to merge the harmonized digital object with the captured environment image. The compositing layer aligns object edges with detected depth boundaries. Optical flow correction ensures continuity between successive frames and eliminates flicker and motion artifacts in the rendered scene.

The one or more processors 202, using the transmission module 220, transmit the optimized rendered at least one digital object to the user device 104. The transmission module 220 communicates with the rendering module 216 to enable display of the at least one digital object within the physical environment on a display of the user device 104. In addition, the transmission module 220 manages packaging, encoding, synchronization, and secure delivery of the harmonized mixed reality (MR) content generated by the system 108. The transmission ensures that the rendered and optimized digital objects are displayed in real time. Also, the transmission ensures seamless integration of the digital objects with the physical environment as viewed through the user device 104.

In an embodiment, the transmission module 220 encodes the harmonized MR content and associated metadata into a structured transmission format. The metadata includes lighting coefficients, color correction matrices, and perspective alignment parameters, optimized for high-speed rendering and low-latency playback. The structured format may include compressed geometry data, texture maps, environmental lighting descriptors, and harmonization vectors encoded within a container format. The container format may include glTF, USDZ, or a proprietary adaptive binary stream. In another embodiment, the transmission module 220 may employ compression techniques such as mesh decimation, JPEG-XL, or Neural Radiance Field (NeRF) encoding. The compression techniques minimize data volume and simultaneously preserve visual quality and frame coherence.

In an embodiment, the transmission module 220 ensures real-time synchronization between the system 108 and the user device 104. The synchronization includes timestamp alignment, frame sequencing, and application of network time protocol (NTP). The synchronization is done to maintain consistent temporal coherence between the optimized MR content and the corresponding physical environment imagery captured by the one or more sensors 104a. The synchronization enables prevention of perceptual lag or mismatch between the virtual and real-world visual layers during user interaction.

In some embodiments, the transmission module 220 supports bi-directional data exchange between the system 108 and the user device 104. The user device 104 may transmit continuous feedback, such as frame rendering latency, illumination changes, or pose estimation data to the system 108. The transmission module 220 uses the feedback to refine streaming parameters, adjust data bitrate, or trigger adaptive re-harmonization updates to maintain perceptual fidelity.

In an embodiment, the transmission module 220 dynamically selects the optimal communication channel from among 5G, Wi-Fi 6, Bluetooth Low Energy (BLE), or satellite-based links, depending on network quality metrics. The multi-channel communication capability enables seamless operation across diverse network environments for uninterrupted mixed reality experiences regardless of bandwidth variability.

In another embodiment, the transmission module 220 supports progressive streaming of the harmonized content. The system 108 may initially transmit coarse-resolution geometry and lighting data to the user device 104 for rapid scene initialization. Also, the system 108 may perform incremental delivery of higher-resolution textures, reflection maps, and shadow details. The layered transmission strategy allows the user device 104 to begin rendering immediately and asynchronously refine scene detail as bandwidth permits.

In some embodiments, the transmission module 220 implements edge-assisted caching and prefetching. The system 108 may store harmonization states, texture atlases, or illumination profiles on nearby edge servers for faster retrieval. In an event of detection of similar lighting or environmental conditions in a subsequent session, the system 108 uses cached harmonization data to minimize latency and computation load.

In an embodiment, the transmission module 220 interacts with the database 120 for session persistence and recovery. The database 120 stores the harmonization parameters, the environmental descriptors, and the digital object metadata transmitted during an MR session. In an event of a session interruption and resumption later, the transmission module 220 retrieves previously stored parameters and resumes transmission from the last known state.

In some embodiments, the transmission module 220 enables multi-user synchronization for collaborative MR experiences. The harmonized digital objects and the lighting metadata are simultaneously streamed to multiple user devices. Each user device operates in distinct and interconnected physical environments. The synchronization algorithms ensure that each user perceives the same harmonized digital objects under consistent lighting and color calibration conditions. The synchronization enables shared MR sessions, such as remote collaboration, virtual training, or coordinated visualization tasks.

In an exemplary use case, when a user scans a real-world object in a dimly lit room, the system 108 performs the harmonization and the optimization of the digital object to match the subdued lighting. The transmission module 220 encodes and streams the harmonized digital object to the user device 104. The digital object appears naturally embedded within the dim environment. If the user moves to a brighter area, the transmission module 220 continues to stream adaptive updates, such as increased brightness and shadow rebalancing. Accordingly, the displayed object remains visually coherent throughout the lighting transition.

The modular architecture of the system 108 allows scalable deployment across devices, supports distributed processing between local and remote systems. Also, the system 108 maintains synchronization of the lighting and the color parameters throughout the harmonization pipeline. In operation, the system 108 continuously updates a rendering context based on sensor feedback, user interactions, and dynamic environmental variations. Accordingly, the system 108 ensures that the digital objects remain perceptually consistent with the real-world surroundings. The architecture of the system 108 prevents cross-interference between concurrent users and enables shared contextual metadata when multi-user collaboration is required.

For example, when a user walks from an indoor environment into outdoor sunlight, the harmonization framework 114 dynamically adjusts the digital object’s brightness and tone to remain consistent with the shifting illumination. Similarly, if the environment includes a transition from warm indoor light to cooler daylight, the harmonization framework 114 automatically performs adaptive color temperature correction to maintain perceptual realism.

In an exemplary scenario, multiple users 102a, 102b, and 102c may simultaneously interact with respective communication devices. Each communication device is embedded with the one or more sensors 104a that capture local environmental conditions such as brightness, ambient color distribution, or shading caused by surrounding objects. For instance, one user may capture a brightly lit office with overhead fluorescent lighting, another may capture a dimly lit living room illuminated by a single lamp, and a third may capture an outdoor environment with dynamic variations caused by a setting sun. The system 108 processes the heterogeneous inputs in parallel, assigning dedicated processing threads to each device and maintains synchronization through timestamp correlation and device identifiers. Environment-specific harmonization data is generated for each session, ensuring that digital objects are rendered with lighting and color adjustments consistent with the local scene. The architecture prevents cross-interference between concurrent users while enabling shared contextual metadata when multi-user collaboration is required.

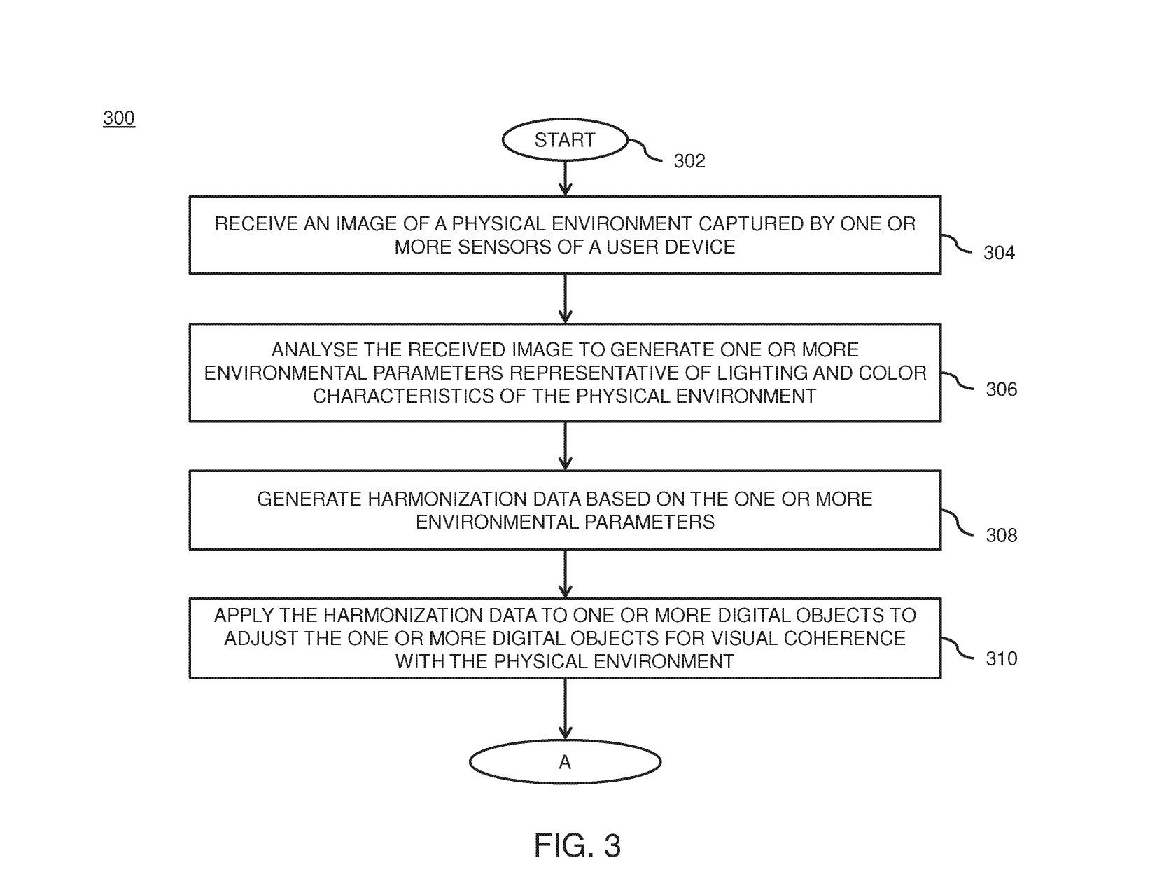

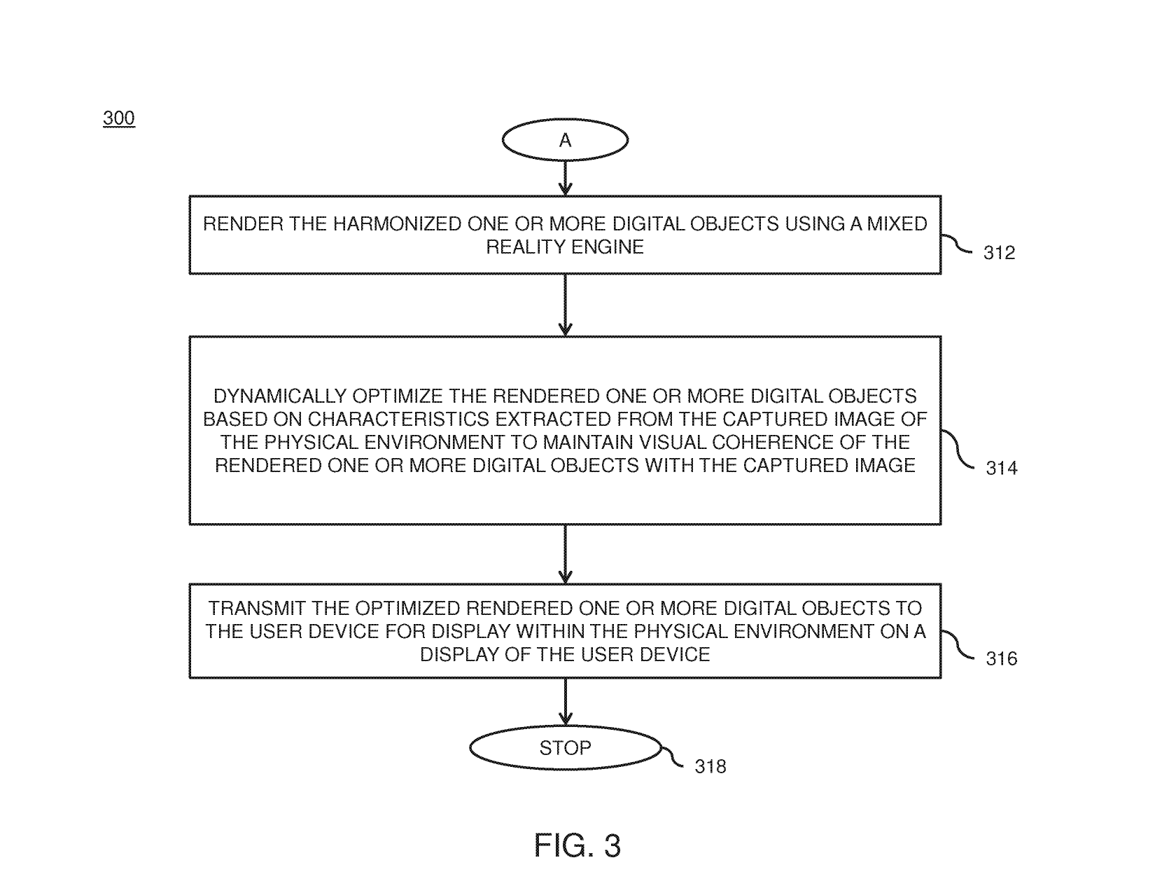

FIG. 3 illustrates a flow chart of a method 300 for the harmonization of the at least one digital object with the lighting conditions of the physical environment in real time, in accordance with various embodiments of the present disclosure. It may be noted that the description of the flowchart 300 refers to FIG. 1 and FIG. 2, and the working and functioning may be read together with the descriptions thereof.

The flowchart 300 initiates at step 302. At step 304, the method includes receiving, from the user device 104, the image of the physical environment captured by the one or more sensors 104a embedded in the user device 104. In an embodiment of the present disclosure, the one or more sensors 104a include at least one of the camera, the depth sensor, or the illumination sensor. The one or more sensors 104a are configured to capture the lighting intensity, the color temperature, and the spatial geometry of the surrounding environment. The image data serves as the primary input for estimating the environmental lighting conditions used for the harmonization of the at least one digital object in subsequent steps.

At step 306, the method includes analyzing the received image to generate the one or more environmental parameters representative of the lighting and the color characteristics of the physical environment. The analysis is performed using the lighting analysis algorithm or the artificial intelligence model 116 trained to extract the photometric features.

In an embodiment, the one or more environmental parameters include at least one of the high dynamic range image (HDRi) map, the CubeMap, the color distribution histogram, the brightness value, or the color temperature of the environment. The one or more environmental parameters are computed by decomposing the captured image into the luminance and the chrominance channels and estimating the directional light vectors, diffuse the reflectance coefficients, and illumination falloff patterns.

At step 308, the method includes generating the harmonization data based on the one or more environmental parameters. The harmonization data includes the one or more adjustments for at least one of the lighting alignment, the color consistency, the saturation, or the perspective scaling of the at least one digital object.

In an embodiment, the generation of the harmonization data includes using at least one of the artificial intelligence model 116 or the non-artificial intelligence algorithm 118. The artificial intelligence model may include the Pixel-Consistency Transformation Network (PCTNet), the Dual-Color Harmonization Network (DucoNet), the saturation estimation model, or the diffusion-based relighting model. The AI models predict the lighting transformations necessary to align the virtual illumination with the real-world lighting captured from the physical environment.

In another embodiment, the harmonization data may include per-pixel lighting coefficients, the tone-mapping curves, the saturation weights, and the ambient occlusion correction parameters. The above stated parameters determine how the digital object’s material and appearance should adapt to match the real-world illumination conditions.

At step 310, the method includes applying the generated harmonization data to the at least one digital object. The harmonization data is applied to enablr adjustment of the at least one digital object for visual coherence with the physical environment. The harmonization data is generated using at least one of the artificial intelligence model 116 or the non-artificial intelligence algorithm 118. The application of harmonization data ensures that the digital object exhibits the same lighting orientation, the color warmth, and the luminance levels as the physical surroundings.

In an embodiment, applying the harmonization data includes adjusting the pixel-level saturation values. In another embodiment, applying the harmonization data includes alignment of the digital object with background-to-foreground color transitions. In yet another embodiment, applying the harmonization data includes correcting the scale or the perspective of the digital object relative to the captured image. In yet another embodiment, applying the harmonization data may include a subset or combination of all the above stated applications. The adjustments are dynamically computed to maintain the natural integration between the real and the virtual components.

At step 312, the method includes rendering the harmonized at least one digital object using the modular mixed reality engine 110. The rendering combines the harmonized digital object with the real-time video feed of the physical environment captured by the camera module of the user device 104. In an embodiment, the rendering step involves blending the lighting-corrected textures, and projecting color temperature–balanced overlays to maintain the perceptual uniformity across virtual and real elements.

At step 314, the method includes dynamically optimizing the rendered at least one digital object based on characteristics extracted from the received image of the physical environment. The dynamic optimization maintains the visual coherence of the rendered at least one digital object with the captured image. The dynamic optimization ensures continuous visual coherence as lighting conditions or user viewpoints change over time.

In an embodiment, the dynamic optimization includes performing the color correction operations that map the pixel intensity values of the rendered object to the pixel intensity distributions of the captured environment. Further, the optimization includes the adaptive reweighting of the luminance and the chrominance values based on the histogram analysis of the physical scene. In another embodiment, the optimization includes prediction of the forthcoming lighting changes using the temporal filtering or the AI-based predictive modeling (for example, using a temporal convolutional network trained on illumination sequences). In an embodiment, the optimization may include material-specific adjustments such as the reflectance modulation or the specular highlight balancing to enhance photorealism of reflective or translucent virtual objects.

At step 316, the method includes transmitting the optimized rendered at least one digital object to the user device 104 for display within the physical environment. The transmission ensures that the harmonized and the optimized MR content is streamed or delivered in real time to the user device 104 for visual integration and interaction. In an embodiment, the transmission enables the multi-user synchronization of the harmonized at least one digital object across multiple devices. The multi-user synchronization includes alignment of the timestamps and the harmonization parameters through network time protocol (NTP). The synchronization ensures all users perceive consistent lighting-aligned objects in the shared MR sessions.

The flowchart 300 ends at step 322. The described steps collectively enable the real-time harmonization of the at least one digital object with the physical lighting conditions. The method enhances realism, maintains the perceptual stability, and supports adaptive rendering under dynamically changing environmental illumination.

The present disclosure is industrially applicable in various domains that involve rendering, visualization, or interaction with digital objects in real-world environments. The disclosed system and method enable consistent photorealistic integration of virtual content across multiple industries utilizing mixed reality (MR), augmented reality (AR), and extended reality (XR) technologies. In the architecture, engineering, and construction (AEC) industry, the disclosed system may be used for real-time visualization of design elements, structural overlays, or simulation of lighting and material behavior in an actual physical space. The harmonization process enables accurate preview of interior lighting, façade shading, and environmental reflections before physical implementation.

In the retail and e-commerce sector, the disclosed system enables dynamic visualization of products in real-world lighting conditions. The system allows customers to view furniture, décor, or fashion items as they would appear under actual illumination.

In industrial maintenance and inspection applications, the harmonization framework allows technicians to overlay diagnostic data, thermal imagery, or repair guidance directly over machinery or equipment to maintain natural lighting alignment and improve situational awareness during field operations.

In the media, entertainment, and gaming industries, the disclosed system supports seamless blending of virtual and real elements in film production, interactive storytelling, and immersive experiences. The harmonized lighting and color integration ensure realistic rendering of characters, effects, and props in live-action environments.

In education and training, the system provides immersive learning experiences by accurately aligning instructional digital objects or simulation elements with physical laboratory environments or field conditions.

The disclosed system is applicable to automotive, defense, and aerospace domains where lighting-consistent augmented visualizations enhance simulation, safety evaluation, and design validation workflows.

Furthermore, the architecture of the disclosed system supports cross-platform deployment and cloud-assisted scalability and allows integration into both standalone and distributed processing environments. The modular design of the system enables implementation in consumer-grade devices as well as enterprise-level systems to ensure adaptability across diverse industrial infrastructures.

Accordingly, the present disclosure is industrially applicable to any system or workflow requiring real-time alignment of virtual and physical visual parameters, and provides a technological foundation for future-generation mixed reality content delivery, intelligent visualization, and adaptive rendering ecosystems.

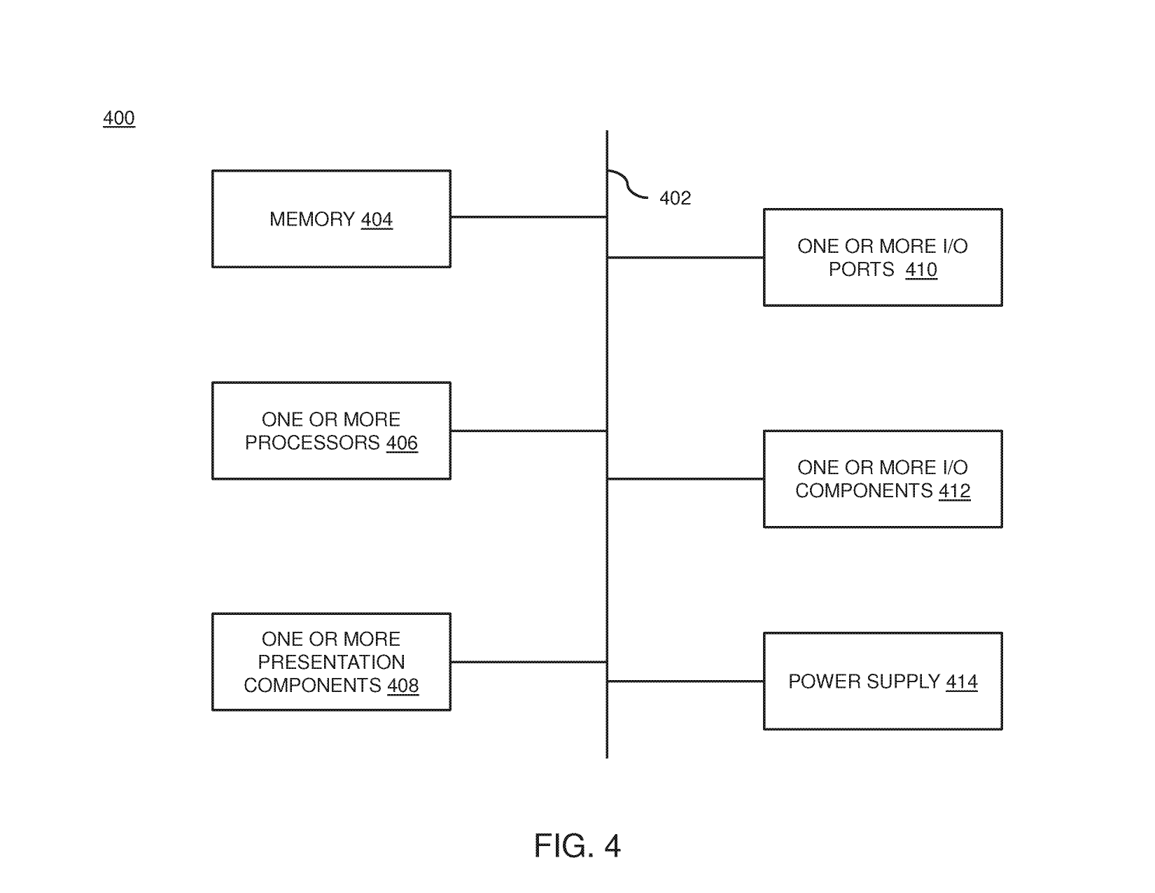

FIG. 4 illustrates a block diagram of an exemplary device 400 configured for executing the harmonization and the rendering of the mixed reality (MR) content, in accordance with various embodiments of the present disclosure. The device 400 is representative of the user device 104 or any computing entity configured to operate the system 108, the modular mixed reality engine 110, and the associated harmonization framework 114. The device 400 may be implemented as a non-transitory computer-readable storage medium storing instructions for harmonizing the at least one digital object with the lighting conditions of the physical environment in real time.

The device 400 includes a bus 402 that directly or indirectly couples a memory 404, one or more processors 406, one or more presentation components 408, one or more input/output (I/O) ports 410, one or more I/O components 412, and a power supply 414. The bus 402 represents one or more communication channels, such as an address bus, a data bus, or a combination thereof, for enabling communication among the device components and supporting high-speed data transfer during the real-time harmonization process.

In practice, the delineation between various components may not be strict, and several elements may overlap in function. For example, a presentation component such as a display may also be considered an I/O component, and a processor 406 may integrate internal cache or embedded memory. The illustration in FIG. 4 is therefore exemplary and non-limiting, serving as a logical representation of hardware elements that collectively enable the real-time harmonization and the rendering of the mixed reality content.

The device 400 includes one or more types of computer-readable media accessible to the processor 406. The computer-readable media may include volatile or non-volatile, removable or non-removable memory elements that store data, the harmonization parameters, and executable instructions.

The computer storage media may include random-access memory (RAM), read-only memory (ROM), electrically erasable programmable read-only memory (EEPROM), flash memory, hard drives, solid-state drives, optical or magnetic discs, or any medium capable of storing data and program instructions. The communication media may embody data or instructions in a modulated data signal, such as a carrier wave, transmitted through wired or wireless communication channels including Wi-Fi, 5G, Bluetooth, infrared, or satellite-based links.

The memory 404 stores computer-readable instructions that, when executed by the one or more processors 406, cause the device 400 to perform the harmonization-related operations such as detecting the environmental lighting, analyzing the captured images, generating the harmonization data, applying the relighting corrections, and dynamically optimizing the rendered at least one digital object. The memory 404 may include segregated data buffers for the high dynamic range maps (HDRi), the CubeMaps, or the pre-computed illumination coefficients used by the harmonization framework 114.

The one or more processors 406 execute the instructions stored in the memory 404 to perform the computational operations required for the harmonization and the rendering processes. The processors 406 may include central processing units (CPUs) for control operations, graphics processing units (GPUs) for shader-based relighting and rendering, digital signal processors (DSPs) for color-space transformations, and artificial intelligence accelerators such as neural processing units (NPUs) or tensor cores for executing the illumination estimation and the color harmonization models. In some embodiments, the processors 406 cooperate to achieve the parallelized harmonization inference to ensure low-latency lighting adaptation during the real-time MR sessions.

The one or more presentation components 408 generate the perceptible output to the user 102. Exemplary components include a display screen or a head-mounted display (HMD) that renders the harmonized MR content, speakers for synchronized spatial audio, and haptic feedback modules that reinforce the depth and the object presence. The presentation components 408 allow the harmonized at least one digital object to appear naturally integrated with the physical environment in terms of rhe lighting, the color tone, and the depth perception.

The one or more I/O ports 410 facilitate communication between the device 400 and external systems, networks, or peripheral sensors. Examples include USB-C, HDMI, DisplayPort, or Thunderbolt interfaces used for connecting external lighting sensors, capture devices, or calibration tools. The one or more I/O components 412 serve as input mechanisms for capturing the user actions or the environmental data. Illustrative components include the camera module, depth sensor, LiDAR scanner, ambient light sensor, microphone, or gesture recognition unit. These components collectively acquire the environmental parameters required for the real-time lighting analysis and the digital object harmonization.

The power supply 414 provides the necessary energy for device operation. The power supply 414 may include a rechargeable lithium-based battery for portable devices such as smartphones, tablets, or wearable displays, or a wired AC/DC power unit for high-performance computing systems such as rendering workstations or MR servers. In some embodiments, the power supply 414 is optimized for the energy-efficient harmonization, employing dynamic voltage and frequency scaling during inactive lighting adaptation cycles.

In operation, the processors 406, the memory 404, and the I/O components 412 operate in the continuous feedback loop to capture the sensor data, compute the harmonization adjustments, and render the visually coherent digital objects. The captured images and the environmental lighting parameters are analyzed by the harmonization framework 114, processed through the AI-based relighting algorithms, and transmitted to the presentation components 408 for display.

In some embodiments, the device 400 communicates with a remote harmonization server or a cloud-based rendering engine to offload computationally intensive processes such as the real-time global illumination mapping or large-scale harmonization model inference. The distributed architecture allows hybrid processing between local and remote nodes, ensuring scalability, bandwidth optimization, and consistent visual quality across multiple user devices.

The arrangement of components shown in FIG. 4 is illustrative and not restrictive. Fewer or additional components may be included depending on implementation requirements. Functions described as being performed by one component may alternatively be distributed across multiple components or modules. The device 400 is therefore representative of a flexible and scalable computing architecture capable of executing the real-time harmonization of digital objects with the dynamically varying lighting conditions of the physical environment across heterogeneous platforms.

The present invention is described hereinafter by various embodiments. The invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of system architectures are identified as suitable for various facets of the implementations. These system architectures are to be treated as exemplary and are not intended to limit the scope of the invention.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A system for harmonizing digital objects with lighting conditions of a physical environment in real time, the system comprising:
one or more processors; and
a non-transitory memory storing instructions, wherein the instructions, when executed by the one or more processors, cause the system to:
receive, from a user device, an image of the physical environment captured by one or more sensors embedded in the user device;
analyze the received image to generate one or more environmental parameters representative of lighting and color characteristics of the physical environment;
generate harmonization data based on the one or more environmental parameters, wherein the harmonization data comprises one or more adjustments for at least one of lighting alignment, color consistency, saturation, or perspective scaling of at least one digital object;
apply the harmonization data to the at least one digital object to adjust the at least one object for visual coherence with the physical environment, wherein the harmonization data is generated using at least one of an artificial intelligence model or a non-artificial intelligence algorithm;
render the harmonized at least one digital object using a modular mixed reality engine; and
dynamically optimize the rendered at least one digital object based on characteristics extracted from the received image to maintain the visual coherence of the harmonized at least one digital object with the physical environment.

2. The system of claim 1, wherein the one or more environmental parameters comprise at least one of a high dynamic range image (HDRi) environment map, a CubeMap, color distribution, a brightness value, or a color temperature.

3. The system of claim 1, wherein the applying of the harmonization data comprises one of or a combination of:
adjusting pixel-level saturation values of the at least one digital object;
aligning the at least one digital object with background-to-foreground color transitions of the received image; and
correcting scale or perspective of the at least one digital object relative to the physical environment.

4. The system of claim 3, wherein the scale correction of the at least one digital object is done based on depth information derived from a high dynamic range image (HDRi) environment map.

5. The system of claim 1, wherein the artificial intelligence model comprises at least one of a pixel-consistency transformation network (PCTNet), a dual-color harmonization network (DucoNet), a saturation estimation model, or a diffusion-based relighting model.

6. The system of claim 1, wherein the at least one artificial intelligence model is configured to correct residual differences between the rendered at least one digital object and the captured image of the physical environment, the correction comprising:
receiving the captured image of the physical environment and the rendered at least one digital object;
extracting pixel-level features comprising at least one of luminance, chrominance, and saturation characteristics from the captured image;
generating feature representations of the rendered at least one digital object;
comparing the extracted pixel-level features of the captured image with the feature representations of the rendered at least one digital object; and
adjusting visual parameters of the rendered at least one digital object based on the comparison to achieve alignment with the captured image.

7. The system of claim 1, wherein the non-artificial intelligence algorithm is configured to correct residual differences between the rendered at least one digital object and the captured image of the physical environment using a background MixNMatch algorithm, the correction comprising:
receiving a rendered output of the at least one digital object and the captured image of the physical environment;
segmenting background regions of the captured image;
extracting color and luminance features from the segmented background regions;
comparing the extracted color and luminance features with corresponding features of the rendered output; and
adjusting pixel values of the rendered output based on the comparison to reduce discrepancies between the background regions and the rendered output and improve visual coherence of the harmonized content.

8. The system of claim 1, wherein the applying of the harmonization data comprises performing pixel-level color temperature correction of the at least one digital object to align with the lighting conditions of the physical environment.

9. The system of claim 1, wherein the dynamic optimization of the rendered at least one digital object using at least one of the artificial intelligence model or the non-artificial intelligence algorithm comprises a color correction operation, the color correction operation comprising:
mapping pixel intensity values of the rendered at least one digital object to pixel intensity distributions of the captured image of the physical environment; and
adjusting, in real time, the pixel intensity values of the rendered at least one digital object based on the mapping.

10. A computer-implemented method for harmonizing digital objects with lighting conditions of a physical environment in real time, the computer-implemented method comprising:
receiving, by one or more processors, from a user device, an image of the physical environment captured by one or more sensors embedded in the user device;
analyzing, by the one or more processors, the received image to generate one or more environmental parameters representative of lighting and color characteristics of the physical environment;
generating, by the one or more processors, harmonization data based on the one or more environmental parameters, wherein the harmonization data comprises one or more adjustments for at least one of lighting alignment, color consistency, saturation, or perspective scaling of at least one digital object;
applying, by the one or more processors, the harmonization data to the at least one digital object to adjust the at least one digital object for visual coherence with the physical environment, wherein the harmonization data is generated using at least one of an artificial intelligence model or a non-artificial-intelligence algorithm;
rendering, by the one or more processors, the harmonized at least one digital object using a modular mixed-reality engine; and
dynamically optimizing, by the one or more processors, the rendered at least one digital object based on characteristics extracted from the received image to maintain visual coherence of the harmonized at least one digital object with the physical environment.

11. The computer-implemented method of claim 10, wherein the one or more environmental parameters comprise at least one of a high dynamic range image (HDRi) environment map, a CubeMap, color distribution data, a brightness value, or a color temperature.

12. The computer-implemented method of claim 10, wherein applying the harmonization data comprises at least one of:
adjusting pixel-level saturation values of the at least one digital object;
aligning the at least one digital object with background-to-foreground color transitions of the received image; and
correcting scale or perspective of the at least one digital object relative to the physical environment.

13. The computer-implemented method of claim 12, wherein correcting the scale of the at least one digital object is performed based on depth information derived from a high dynamic range image (HDRi) environment map.

14. The computer-implemented method of claim 10, wherein the artificial intelligence model comprises at least one of a pixel-consistency transformation network (PCTNet), a dual-color harmonization network (DucoNet), a saturation estimation model, or a diffusion-based relighting model.

15. The computer-implemented method of claim 10, wherein dynamically optimizing the rendered at least one digital object using the artificial intelligence model comprises correcting residual differences between the rendered at least one digital object and the captured image of the physical environment.

16. The computer-implemented method of claim 10, wherein dynamically optimizing the rendered at least one digital object using a non-artificial-intelligence algorithm comprises correcting residual differences using a background MixNMatch algorithm.

17. The computer-implemented method of claim 10, wherein applying the harmonization data comprises performing pixel-level color temperature correction of the at least one digital object.

18. The computer-implemented method of claim 10, wherein dynamically optimizing the rendered at least one digital object comprises performing a color correction operation based on histogram analysis of the captured image.

19. A non-transitory computer-readable medium storing instructions that, when executed by one or more processors, cause a system to perform a method for harmonizing digital objects with lighting conditions of a physical environment in real time, the method comprising:
receiving, from a user device, an image of the physical environment captured by one or more sensors embedded in the user device;
analyzing the received image to generate one or more environmental parameters representative of lighting and color characteristics of the physical environment;
generating harmonization data based on the one or more environmental parameters, wherein the harmonization data comprises one or more adjustments for at least one of lighting alignment, color consistency, saturation, or perspective scaling of at least one digital object;
applying the harmonization data to the at least one digital object to adjust the at least one digital object for visual coherence with the physical environment, wherein the harmonization data is generated using at least one of an artificial intelligence model or a non-artificial-intelligence algorithm;
rendering the harmonized at least one digital object using a modular mixed-reality engine; and
dynamically optimizing the rendered at least one digital object based on characteristics extracted from the received image to maintain visual coherence of the harmonized at least one digital object with the physical environment.
